(19) United States
(12) Patent Application Publication
(10) Pub. No.: US 2023/0350975 A1
(43) Pub. Date: Nov. 2, 2023

(54) PERIODIC POINT PROCESSES AND METHODS

(71) Applicant: AMERICAN UNIVERSITY, Washington, DC (US)

(72) Inventor: Stephen D. CASEY, Ashburn, VA (US)

(21) Appl. No.: 18/138,821

(22) Filed: Apr. 25, 2023

Related U.S. Application Data
(60) Provisional application No. 63/336,723, filed on Apr. 29, 2022.

(51) Int. Cl. G06F 17/14; G06F 17/15

(52) U.S. Cl. CPC G06F 17/141; G06F 17/156

(57) ABSTRACT

Methods and Systems to analyze data from multiple periodic processes and deinterleave those periods including providing process data for analysis from at least one periodic generator; identify underlying different periodic processes; providing a Modified Euclidean Algorithm (MEA) to extract a fundamental period from a set of sparse and noisy observations of a periodic process; relying on the probabilistic interpretation of an equidistributed MEA (EQUIMEA) to deinterleave processes with multiple periods; and outputting the deinterleaved data to be applied to desired applications and analyses. The method may converge to the exact value of the period with as few as ten data samples. Desired applications may include communication and signal processing, bio-rhythms, aggregate business data, signal analysis of radar and sonar systems, queuing in business applications, analysis of neuron firing rates in computational neuroscience, bit synchronization in communications, fading communication channels, detecting patterns in spatial point processes, and the like.

### STATEMENT OF GOVERNMENT INTEREST

This invention was made with government support under Grant No. DE-FA9550-20-1-0030 awarded by the U.S. Air Force Office of Scientific Research (AFOSR). The Government has certain rights in the invention.

### FIELD

The present embodiments relate generally to frequency agility with tight thresholds on noise levels, and specifically to the deinterleaving and analysis of data and processes with multiple periods.

### BACKGROUND

The analysis of point processes is an important component of data analysis, appearing in everything from signal analysis of radar systems, queuing in business applications, to the analysis of neuron firing rates in computational neuroscience. Determining if data has been generated by one or several periodic processes can give a key component in the analysis of the information.

Methods for smoothing denoising filters have been proposed, for example various standard spatial domain filters. Additionally, the 2-D Gaussian filter and median filter have also been widely applied. While the most commonly used is the Lee filter, it requires knowledge of interferometric coherence. The adaptive contoured-window filter method and the two-stage filtering method can also reduce noise effectively.

However, problems in these systems remain.

Despite advances in the art, there is a desire and need to provide systems and methods of signal analysis and data processing communities, and arises in numerous situations, e.g., communication and signal processing, astronomy, biomedical applications, physical systems, reliability, business application, quality control and the like. Probabilistic algorithms, which in theory, when applied in a simulation given the same time delay and received signal attenuation, are desired to be more effective and robust even when the receiver receives a very weak signal.

Unless otherwise indicated herein, the materials described in this section are not prior art to the claims and are not admitted as being prior art by inclusion in this section.

### SUMMARY

Accordingly, to advance at least the aforementioned deficiencies in the art, described herein are systems and methods to analyze data from multiple periodic processes and deinterleave those periods. The present systems and methods may in some approaches rely on the probabilistic interpretation of the Riemann zeta function, the equidistributional theorem of Weyl, and Wiener's periodogram (EQUIMEA). The deinterleaved data is then outputted to be applied to various applications and analyses in numerous situations, e.g., communication and signal processing, astronomy, biomedical applications, physical systems, business applications, reliability tests and algorithms and quality control. There are not systems that can work with extremely sparse noisy data. The procedures discussed in this document work in these sparse data/high noise space environment when no other algorithms work.

The proposed algorithms in some embodiments enable frequency agility (or “frequency hopping”). This is the ability of, for example, a radar system to quickly shift its operating frequency to account for atmospheric effects, jamming, mutual interference with friendly sources, or to make it more difficult to locate the radar broadcaster through radio direction finding. These same algorithms/processing/methods and systems may also be applied to other fields including lasers or traditional radio transceivers using frequency-division multiplexing, bio-rhythms, aggregate business data and the like to de-interleave multiple overlayed data period sets.

While the disclosed algorithms have great potential in the aerospace and defense arena, there is equal desire for their application in consumer electronics industry. For example, the reason that several cell phones can be used at the same time in the same location is due to the use of frequency hopping. When a user wishes to place a call, the cell phone uses a negotiation process to find unused frequencies among those that are available within its operational area. This allows users to join and leave particular cell towers on-the-fly with their frequencies assigned to other users as needed.

The proposed technology may comprise two algorithms, the MEA (Modified Euclidean Algorithm) and the EQUIMEA (Equidistributed Modified Euclidean Algorithm), which are designed to work on all one-dimensional periodic processes. Specifically, it is expected that these algorithms could be effectively useful on sparse datasets where other procedures (e.g., least squares, Wiener periodograms) breakdown. An ME point access algorithm may work on data from single-period processes, as it computes an estimate of the underlying period. It was created to be computationally efficient and straightforward with the ability to work on all single period processes. Overall, the algorithm justification rests on deep mathematics including a probabilistic interpretation of the Riemann zeta function. Building on these procedures data can be analyzed from multiple periodic processes and deinterleave the processes. This relies on the probabilistic interpretation of the Riemann zeta function, the equidistributional theorem of Weyl, and Wiener's periodogram (EQUIMEA).

These algorithms support the queuing theory used in a wide range of tasks, from analyzing the occurrences of radar pulses in signal analysis to customer arrival times in business to neuron firing rates in computational neuroscience. Specifically, the present processes and methods may be applied the computation model to radar and communication systems, to demonstrate the theoretical ability to enhance frequency agility (“frequency hopping”). The present processes and methods will lend a positive impact to radar and sonar performance as well as bit synchronization in communications. It will also address unreliable measurements in a fading communication channel and compute the “jump times” of a pseudo randomly occurring change in the carrier frequency of frequency-hopping radio. Here the change rate is governed by shift register outputs, in such case, the developed algorithm can help determine the underlying fundamental period.

In one approach, a method to analyze data from multiple periodic processes and deinterleave those periods may have the steps of: providing process data for analysis from at least one periodic generator; identify underlying different periodic processes; providing a Modified Euclidean Algorithm (MEA) to extract a fundamental period from a set of sparse and noisy observations of a periodic process; relying on the probabilistic interpretation of an equidistributed MEA (EQUIMEA) to deinterleave processes with multiple periods; and outputting the deinterleaved data to be applied to desired applications and analyses.

In one approach, the method converges to the exact value of the period with as few as ten data samples.

According to another approach, the desired applications and analyses may be selected from the group of communication and signal processing in the fields of traditional radio transceivers using frequency-division multiplexing, bio-rhythms, aggregate business data, astronomy, biomedical, physical systems, reliability and quality control systems, signal analysis of radar and sonar systems, queuing in business applications, analysis of neuron firing rates in computational neuroscience, bit synchronization in communications, fading communication channels, hop times of frequency-hopping radios, detecting patterns in spatial point processes, and the like.

According to another approach, the MEA processes may provide that for a set of randomly chosen positive integers, the probability they do not all share a common prime factor approaches one quickly as the cardinality of the set increases.

According to another approach, the EQUIMEA processes may include an extraction of a set of fundamental periods by using Weyl's Equidistribution Theorem to help separate sources.

According to another approach, the deinterleaving processes may use convolution with appropriate pulse trains.

According to another approach, the signal processing of hop times may use standard signal processing tools of discrete Fourier transforms and convolution operators; and non-standard tools of abstract algebra and number theory.

According to another approach, the detecting patterns in spatial point processes may be used to determin co-linearity in minefields.

According to another approach, the providing a first procedure to extract a fundamental period first assumes that the sample is noise free, then adjusting for noise.

According to one approach, a method to analyze data from multiple periodic processes and deinterleave those periods may comprise the steps of:
1.) [Adjoing 0.] Sᵢₜₑᵣ←S∪{0};
2.) [Sorting.] Sort the elements of Sᵢₜₑᵣ in descending order;
3.) [Computing all differences.] Set Sᵢₜₑᵣ=∪(sⱼ−sₖ) with sⱼ>sₖ;
4.) [Eliminating noise.] If 0≤sⱼ≤η₀, then S←S\{sⱼ};
5.) [Adjoining previous iteration.] Form Sᵢₜₑᵣ←Sᵢₜₑᵣ∪Sᵢₜₑᵣ−1, sort and reindex;
6.) [Computing spectrum.] Compute

$$\vert {Spec}_{iter} ( τ ) \vert = \vert {\sum }_{l = 1}^{N} {e}^{( \frac{2 π {is}_{l}}{τ} )} \vert ;$$

7.) [Thresholding.] Choosing the rightmost peak. Label it as τᵢₜₑᵣ;
8.) If |Specᵢₜₑᵣ(τᵢₜₑᵣ)|>ε_{β} or |τᵢₜₑᵣ−τᵢₜₑᵣ₋₁|<ε_{η}, declaring [symbol] =τᵢₜₑᵣ; If not, iter←(iter+1). Go to 1.);
9.) Given τᵢ, removing it and its harmonics |Specᵢₜₑᵣ(τ)| for [symbol] /m, m∈ [symbol] . Labeling as Notchᵢₜₑᵣ(τ);
10.) [Recomputing frequency notched spectrum.] Compute |Specᵢₜₑᵣ(τ)−Notchᵢₜₑᵣ(τ)|;
11.) [Thresholding.] If |Specᵢₜₑᵣ(τ)−Notchᵢₜₑᵣ(τ)|≤ε_{β} algorithm terminates. Else, let i←i+1; and
12.) [Deinterleaving the data].

According to one approach, the step of detinerleaving the data may comprise correlating a known delayed signal with an unknown signal to detect the presence of the template in the unknown signal using discrete matched filtering; and convolving the data given the original data and the set of generating periods to identify the elements in the original data.

Other features will become more apparent to persons having ordinary skill in the art to which the processes and methods pertain and from the following description and claims.

### BRIEF DESCRIPTION OF THE DRAWINGS

The present embodiments, as well as a non-limiting exemplary mode of use, further objectives and advantages thereof, will best be understood by reference to the following detailed description of an illustrative embodiment when read in conjunction with the accompanying drawings, wherein:

FIG. 1 illustrates an exemplary One Period Original Data

FIG. 2 illustrates an exemplary One Period EQUlter3 Spectrum

FIG. 3 illustrates an exemplary Two Periods Original Data

FIG. 4 illustrates an exemplary Two Periods EQUlter2 Spectrum

FIG. 5 illustrates an exemplary Two Periods Deinterleaved

FIG. 6 illustrates an exemplary Three Periods Original Data

FIG. 7 illustrates an exemplary Three Periods EQUlter2 Spectrum

FIG. 8 illustrates an exemplary Three Periods Deinterleaved

FIG. 9 illustrates an exemplary Sparse Two Period

FIG. 10 illustrates an exemplary Sparse Two Period Spectrum

FIG. 11 illustrates an exemplary Sparse Two Period Deinterleaved

FIG. 12 illustrates a system that may be used in processing signals in accordance with at least some embodiments.

FIG. 13 illustrates a system for use in implementing methods, techniques, devices, apparatuses, systems, modules, units and the like in providing user interactive virtual environments in accordance with some embodiments.

Corresponding reference characters may indicate corresponding components throughout the several views of the drawings. Skilled artisans will appreciate that elements in the figures are illustrated for simplicity and clarity and have not necessarily been drawn to scale. For example, the dimensions/peaks of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

The analysis of point processes is an important component of data analysis and applications. Determining if data has been generated by one or several periodic processes can give a key component in the analysis of the information. This analysis can be of interest to applictions involving the signal analysis and data processing communities, and arises in numerous situations. Some non-limiting examples include communication and signal processing, astronomy, biomedical applications, physical systems, reliability, quality control, signal analysis of radar systems, queuing in business applications, analysis of neuron firing rates in computational neuroscience, and the like.

The present methods (e.g., methods, systems, applications and processes) may be divided into two parts/cases: first periodic processes created by a single source, and second those processes created by several sources. The methods extract the fundamental period of the sets, and, in the second case, deinterleave the processes. The usual method of dealing with this type of data involve Wiener periodograms. However, for many data sets (as described herein), these methods break down. They are replaced instead with applications by methods using number theory and statistics. Periodograms, however, as shown below, deinterleave data with more than one period. The periodograms become effective tools because of the work done by number theory in the first part.

Accordingly, two algorithms are provided herein for the applications presented herein. Thew algorithms are designed to work on all one dimensional periodic processes, but work effectively, in particular, on sparse data sets where other procedures, e.g., least squares, Wiener periodograms, break down. The first algorithm works on data from single-period processes, computing an estimate of the underlying period. It is extremely computationally efficient and straightforward and works on all single-period processes. Its justification rests on some deep mathematics, including a probabilistic interpretation of the Riemann zeta function. Next this procedure is built upon to analyze data from multiple periodic processes and then deinterleave the processes. These analyses rely on the probabilistic interpretation of, for example, the Riemann zeta function, the equidistribution theorem of Weyl, and Wiener's periodogram. Both algorithms rely on the structure of randomness, which tells that random data can settle into a structure based on the set from which the data is extracted (2020 AMS Subject Classification: 11A05, 11K60, 41-04, 42-08, 65T99. Keywords: point processes, periodic processes, ergodic theory, Riemann Zeta Function, Weyl's Equidistribution Theorem).

### INTRODUCTION

Point processes are an important component of data analysis, from the queuing theory used to analyze customer arrival times in business to the occurrences of radar pulses in signal analysis to the analysis of neuron firing rates in computational neuroscience. Spatial point precesses are key in subjects ranging from agriculture and forestry to epidemiology, seismology, and materials science. The analysis of point processes breaks down into various subcategories—spatial, stochastic, Poisson, Markov, etc. A fundamental problem is the analysis of periodic point processes generated by one or several underlying periods.

The present embodiments can provide analyses with one dimensional data, which can be viewed as a sequence of event times. The methods seek to determine if data has been generated by periodic processes, and if so, extract the period or periods from the data and apply to a desired application as referenced above. If there are several periods, the methods may deinterleave the data into separate periodic processes each generated by a single period. Two presented two algorithms (with theoretical justification) address these points. The algorithms are designed to work on all one dimensional periodic processes, but in particular on sparse data sets where other procedures, e.g., least squares, Wiener periodograms, . . . , break down. A probabilistic view of the Riemann zeta function, procedures on generalizations of Euclidean domains, and variations on equidistribution theory have led to procedures for several classes of problems in periodic parameter estimation. These procedures are general and very efficient and can be applied to the analysis of periodic processes with a single period and to the deinterleaving and analysis of processes with multiple periods. The present embodiments provide algorithms and analysis as to why they work. Both algorithms rely on the structure of randomness (see below), which tells that random data can settle into a structure based on the set from which the data is extracted.

The first procedure, the Modified Euclidean Algorithm or MEA (The names for the algorithms becomes obvious when one understands their underlying mechanisms), is a very efficient algorithm for extracting the fundamental period from a set of sparse and noisy observations of a periodic process. Given that the data is time of arrival or, more accurately, time of occurrence, the noise is jitter noise, a variation around the exact location of the event. Noise is modeled as an additive random variable. The MEA works on all single-period periodic point processes, but in particular, when the standard tools break down. The procedure is computationally straightforward, stable with respect to noise, and converges quickly. Variations on equidistribution theory lead to a second algorithm, the Equidistributed MEA or EQUIMEA, works for several classes of problems in periodic parameter estimation. The second algorithm is also general and very efficient and can be applied to the deinterleaving and analysis of processes with multiple periods.

In the case of a single period, the MEA algorithm may use the theory of numbers in novel ways to extract the underlying period by modifying the Euclidean algorithm to determine the period from a sparse set of noisy measurements [6, 7, 42, 43]. Of note in sample data sets is the sparseness of the data. The elements are the noisy occurrence times of a periodic event with missing measurements. Think of the data elements as the zero crossings of a sinusoid. With all or nearly all of those zero crossings, least squares will lead to recovering the period, even in a relatively noisy environment. However, say that a random process has removed more and more of these zero crossings. Least squares, Wiener's periodogram, etc., break down. These issues are discussed in [6, 7, 9, 10], and detailed comparisons are given in [7, 43]. In particular, the one paper [43] gives a very thorough analysis, comparing the MEA algorithm to other methods. Given even 25% missing data, the MEA method was superior and worked in situations (≥50% missing data) where other methods did not produce meaningful results. This approach is justified by some deep mathematics, including a probabilistic interpretation of the Riemann zeta function. This allows to prove a result (Theorem 1) which shows that in an arbitrarily large lattice of positive integers in n-dimensional Euclidean space, if choose an element of the lattice is chosen, the probability that the n-tuple is relatively prime quickly converges to certainty as n increases. Given noise-free data, the algorithm very likely converges to the exact value of the period with as few as ten data samples. If the data contains additive noise, simulation results show, e.g., a very good estimation of the period from one hundred data samples with fifty percent of the measurements missing and twenty-five percent of the data samples being arbitrary outliers [7, 43, 42]. In the noise-free case this implies nearly certain convergence with only ten data samples (see Table 2), independent of the percentage of missing measurements. In the case of noisy data simulation results show, for example, good estimation of the period from ten data samples, converging as noise decreased and the number of data points increased (see Table 3).

The EQUIMEA procedure works on periodic processes created by several sources, each with different underlying periods. It extracts the set of fundamental periods by using Weyl's Equidistribution Theorem to help separate sources. Given, say, two periods τᵢ and τ_{i′}, differences of their respective multiples will reinforce each other, but intermixed differences will, with probability one, be incommensurate to both τᵢ and τ_{i′} i.e., is not equal to a rational multiple of either number. The relative primeness of data generated by one period will “fill in” the missing elements for that period, whereas the data from two different periods will become “Weyl flat.” Theoretically, if the process were allowed to go on indefinitely, it would become ergodic, with the sets of differences from different periods becoming a set of full measure, while the set of differences from the same period remaining as a set of measure zero (see Theorem 3). A sliding periodogram is done to highlight the periods.

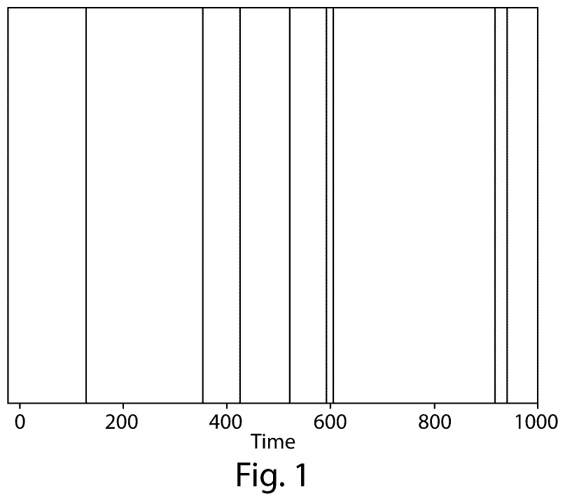

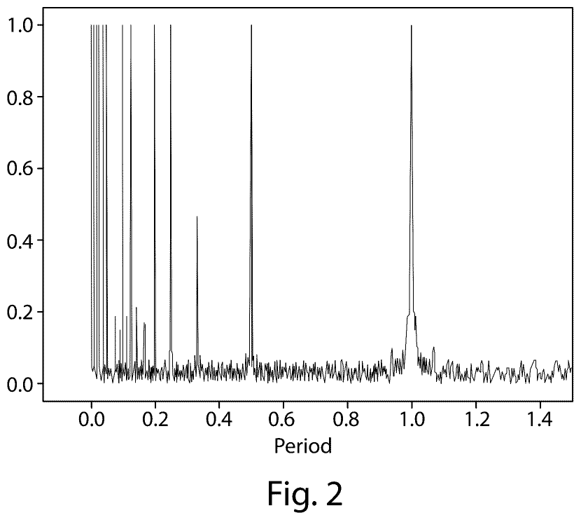

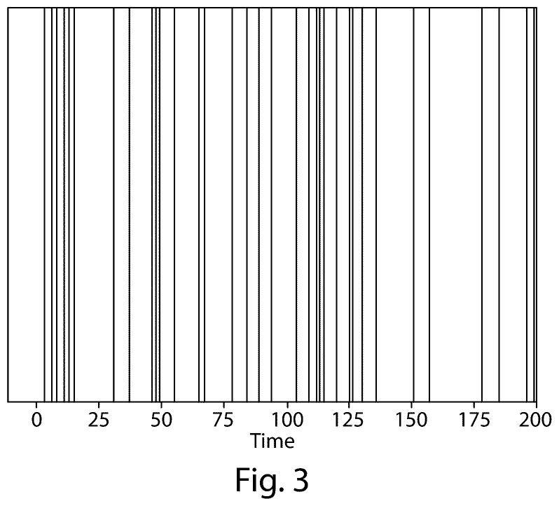

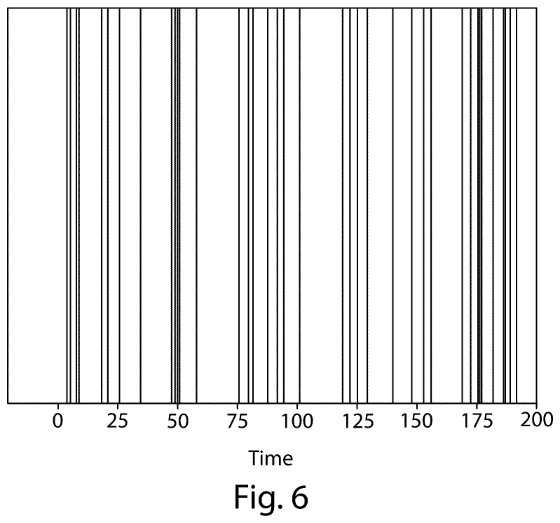

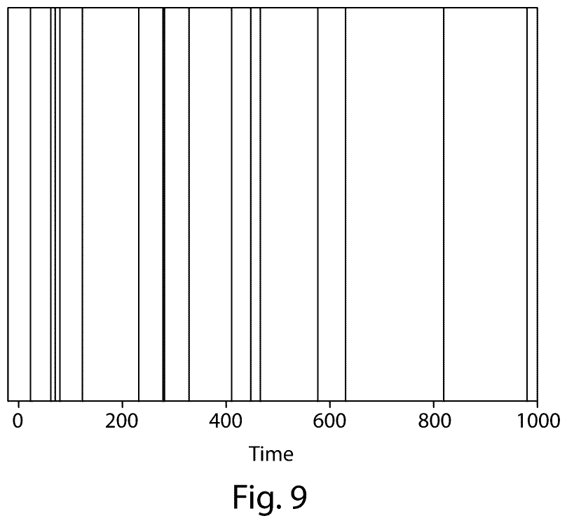

Using these periods, deinterleaving the processes may occur. This is presented by demonstrating the algorithm on four different data sets, all with at least 90% missing observations—a sparse single period set (FIGS. 1-2), a sparse set with two periods analyzed then deinterleaved (FIGS. 3-5), a sparse set with three periods analyzed then deinterleaved (FIGS. 6-8), and an extremely sparse set (99% missing data) with two periods analyzed then deinterleaved (FIGS. 9-11).

Below the development of the MEA algorithm is provided and including the basic number theory and statistics needed to understand the procedure. It also includes the results of computer simulations. Next, the result results are provided, which tell that for a set of randomly chosen positive integers, the probability they do not all share a common prime factor approaches one quickly as the cardinality of the set increases. This section gives the mathematical justifications that the MEA quickly converges to a likely estimate of the underlying period of the point process.

In the next section a description and analysis is provided of the deinterleaving procedure, the EQUIMEA. Weyl's Equidistribution Theorem plays a key role in this work, but it is noted that the “engine” for the EQUIMEA is the MEA. The deinterleaving processes use convolution with appropriate pulse trains.

Several simulations of the EQUIMEA are also provided, including the deinterleaving of data sets with multiple periods.

Single Period Case: The MEA

The data is modeled as a finite set of real numbers

S={sⱼ}ⱼ₌₁ⁿ, with sⱼ=kⱼτ+ϕ+ηⱼ, (1)

where τ (the period) is a fixed positive real number, the kⱼ's are non-repeating positive integers, j (the phase) is a real random variable uniformly distributed over the interval [0, τ) and the ηⱼ's are zero-mean independent identically distributed (iid) error terms. The generator of the process is referred to as τ. It is also assumed that the ηⱼ's have a symmetric probability density function (pdf) and that

$$\vert {η}_{j} \vert < \frac{τ}{2}$$

for all j. By the assumption that the kⱼ's are increasing, it can interpret the sⱼ's as an increasing sequence of occurrence times with time gaps or jumps determined by the kⱼ's. (Later the data can be reordered for analysis; this does not alter the time-of-occurrence interpretation.) Note that for any solution τ that fits the form of S, the numbers

$$\frac{τ}{2} , \frac{τ}{3} , … ,$$

which is referred to as harmonics of τ, are also possible solutions. Estimates of τ in turn lead to estimates of the phase ϕ and the jumps kⱼ's [6, 7, 9, 42, 43].

A way to visualize a given data set is to considered it as a set of zero-crossings. If

$$f ( t ) = sin ( \frac{π}{τ} t - ϕ ) ,$$

then S is a finite subset of the zero-crossings of ƒ with missing observations and jitter noise—small perturbations in the zero-crossings. The data sets given to work with on FHSS were extremely sparse. Some of the data sets had up to 99% of the zero crossings of the sinusoid removed. Other data sets had as few as 10 elements. Still others had more data but had perceptibly more jitter noise.

The problem of finding τ given the set (1) arises in various ways that are often associated with event times. Signal processing engineers usually model event times with a set of Dirac delta functionals called a pulse train. The frequency hopping radio problem requires the analysis of a set of hop times. Other applications include radar pulse repetition interval analysis, bit synchronization in communication systems and biomedical applications, e.g., neuron firing rate analysis. The analysis of event times is approached in various ways, which boil down to three different categories: binning and searching, Fourier analysis (periodogram-based methods for spectral analysis of the pulse train), and the method described herein. The papers [7, 42, 43, 47] contain references from the statistical signal processing literature.

The problem of finding τ is solved by developing an algorithm. Variations of the procedure found in [7, 43, 42, 47] handle very noisy data. The algorithm is computationally straightforward and requires little input data. Given reasonable data, it quickly converges with very high probability to either the exact value of ι (when the data is noise-free) or an estimate \hat{τ} (when the data has additive noise). A fundamental result is given by Theorem 1, which states that for a set of uniformly distributed positive integers contained in an arbitrarily large lattice, the probability that the integers all do not share a common prime factor approaches one quickly as the cardinality of the set increases. In the noise-free case the algorithm converges with very high probability given only n=10 data samples, independent of the number of missing measurements. In the presence of noise (non-zero ηⱼ's in (1)) and false data (or outliers), there is a tradeoff between the number of data samples, the amount of noise and the percentage of outliers. The present algorithm performs well given low noise for n=10, but will degrade as noise is increased. However, given more data, various techniques can be used to reduce noise effects and speed up convergence.

The MEA algorithm was originally developed to analyze a very specific set of signals—hop times of frequency-hopping radios. Frequency-hopping spread-spectrum (FHSS) radio technology is a wireless technology that spreads signals over rapidly changing frequencies. Each available frequency band is divided into subfrequencies. Signals rapidly change, or “hop,” among these subfrequency bands in a pre-determined order. The data sets that needed analyzing were generated by the radios. The FHSS radio network is able to tune and retune, i.e., hop in frequency, in a seemingly random pattern of choices of carrier frequency. Without the technology to analyze the signal environment quickly, it is not possible to discern a coherent message. The task of estimating the underlying hop timing of the network is desired. Extremely fast acousto-optic devices computes a windowed discrete Fourier transform of the signal, generating a data set containing the measurements of the rapidly changing carrier frequencies. The sequence of hop times is realized as (extremely noisy and sparse) changes of location in frequency space. Buried in all of this information was the signature—the fundamental clock cycle—that would allow the carrier frequencies to be tracked, which in turn made it possible to “listen” to the message. The first and most fundamental problem in analyzing information from the hopping radios was to extract this fundamental clock cycle. It is embedded in the sequence of frequency hop times. The times were strictly increasing, seemingly random, but were generated by a periodic process. Solving the problem of extracting this fundamental unit required the use of standard signal processing tools—discrete Fourier transforms and convolution operators—and some non-standard tools—abstract algebra and number theory.

The MEA extracted the underlying hop period of the radios, even in the case of extremely sparse and noisy data. It proved to be useful for a wide variety of tasks. The data sets that can be analyzed include radar pulse repetition interval (PRI) analysis, bit synchronization in communications, and FHSS radio technology applications. It also solved other problems in the analysis of point processes. The algorithm can be used to detect patterns in spatial point processes, e.g., determining co-linearity in minefields ([31]).

An Algorithm for Finding τ

First assume that S is noise-free, i.e., ηⱼ=0 for all j. The following surprisingly simple yet efficient algorithm is presented. This version is preliminary. The next version adjusts to noise. Let \hat{τ} denote the value the algorithm gives for τ, and let “←” denote replacement, e.g., “a←b” means that the value of the variable a is to be replaced by the current value of the variable b.
Initialize: Sort the elements of S in descending order. Set iter=0.
   1.) [Adjoin 0 after first iteration.] If iter>0, then S←S∪{0}.
   2.) [Form the new set with elements (sⱼ−sⱼ₊₁).] Set sⱼ←(sⱼ−sⱼ₊₁).
   3.) Sort the elements in descending order.
   4.) [Eliminate zero(s).] If sⱼ=0, then S←S\{sⱼ}.
   5.) The algorithm terminates if S has only one element s₁. Declare \hat{τ}=sⱼ. If not, iter←(iter+1). Go to (1.).

This procedure is tested on the set of numbers S={ϕ+12τ, ϕ+8τ, ϕ+5τ, ϕ+3τ}.

TABLE 1
The algorithm applied to S

| Initial | Iter 1 | Iter 2 | Iter 3 | Iter 4 | \hat{τ} |
|---|---|---|---|---|---|
| ϕ + 12τ | 4τ | 2τ | τ | τ | \hat{τ} = τ |
| ϕ + 8τ | 3τ | τ | τ | | |
| ϕ + 5τ | 2τ | τ | | | |
| ϕ + 3τ | | | | | |

Remarks. Note, after the first iteration, the phase term ϕ is gone. Given a set of integers, the largest integer that divides all of the integers is called the greatest common divisor (gcd) of that set. Note that the largest integer that divides {12,8,5,3} (the gcd) is 1. If the algorithm is rum on the data set {ϕ+21τ, ϕ+15τ, ϕ+9τ, ϕ+3τ}, the result would be \hat{τ}=3τ. Note that the gcd of {21,15,9,3} is 3.

The FHSS data obtained from the spectrum analyzer, reporting the onset time of each frequency hop, always contained error. The spectrum analyzer output was quantized in time, and detection was obtained by examining several reports over time and estimating the onset time for a particular hop at a particular carrier frequency. This is modeled as additive noise contaminating the time report, i.e.,

S={sⱼ}ⱼ₌₁ⁿ, with sⱼ=kⱼτ+ϕ+ηⱼ.

To deal with the noise, a threshold η₀ is set, and step 4 modified as follows:
4.) 1. If 0≤sⱼ≤η₀, then S←S\{sⱼ}.
   The parameter η₀ can be set a priori, adaptively, or by using a combination of a priori information and adaptive methods.

The Modified Euclidean Algorithm (MEA)

Given noisy data as modeled by set S (as in (1)), a modified subtractive form of the Euclidean algorithm was created to develop a procedure for finding τ. To explain why the algorithm works, some number theory is needed (including analytic number theory), and cites the references Edwards [15], Hardy and Wright [22], Ireland and Rosen [24], Knuth [28], Leveque [34], Rosen [41], and Schroeder [46].

Knuth calls the Euclidean algorithm the grandfather of all algorithms because it is the oldest algorithm still in use [28, p. ^{˜}318]. It is a process determining the structure of a set of positive integers. Given two positive integers a and b, b<a, then b divides a if there exits a positive integer k such that a=k·b. This is denoted by b|a. An integer p>1 which has no divisors other than 1 and itself is a prime. An integer m>1 that is not prime is called a composite. Prime numbers form “the atoms” of the integers. The Fundamental Theorem of Arithmetic (see Rosen [41, p. ^{˜}97]) gives that every positive integer ≥2 is a product of powers of primes, unique up to the ordering of the primes. The Euclidean algorithm is based on the property that, given two positive integers a and b, a>b, there exist two positive integers q and r such that a=q·b+r, 0≤r<b. If r=0, then b divides a. The procedure yields the greatest common divisor of two (or more) positive integers. The greatest common divisor is the product of the powers of all prime factors p that divide the integers.

The Euclidean algorithm applied to a, b, a>b, may be presented as follows:
1.) a=b·q+r:0≤r<b.
2.) The algorithm terminates if r=0. Set gcd(a, b)=b.
3.) Set a←b and b←r. Go to (1.).
   Extensions of the algorithm to higher dimensions can be found in the work of Ferguson, Forcal et. al. [18, 19].

The data sets provided herein present challenges to the standard Euclidean algorithm. First note that there are more than two elements. The symbol gcd(k₁, . . . , kₙ) is the greatest common divisor of the set {kⱼ}. It is very important to note that this is not the pairwise gcd of the set {kⱼ}. If gcd(k₁, . . . , kₙ)=1, the set {kⱼ} is called mutually relatively prime. If, however, gcd(kᵢ, kⱼ)=1 for all i [symbol] j, the set {kⱼ} is called pairwise relatively prime. If a set is pairwise relatively prime, it is mutually relatively prime. However, the converse is not true. (For example, consider the set {35,55,77}. Note that no pair in this set is relatively prime, but the entire set is mutually relatively prime.)

The gcd of a set of more than two integers can be computed as follows. There is also a natural extension of the gcd to multiples of a fixed real number τ>0.

Proposition 1

gcd(k₁, . . . ,kₙ)=gcd(k₁, . . . ,kₙ₋₂,(gcd(kₙ₋₁,kₙ))) (i.)

gcd(k₁τ, . . . ,kₙτ)=−τgcd(k₁, . . . ,kₙ). (ii.)

Proof. See Leveque [34, p. 16].

Let gcd(k₁, . . . , kₙ)=K, and so gcd(k₁τ, . . . , kₙτ)=Kτ. Then, Kτ plays the role of the “fundamental unit” of the set S={k₁τ, . . . , kₙτ}. The elements in the set S are commensurate to Kτ. Every element in the set S can be expressed as an integer multiple of Kτ. (For example, the elements of the set {⅗, 8/5, 3} are commensurate to ⅕.) (Note, gcd(3,8,15)=1.) If no such fundamental unit exists, the elements of the set are called incommensurate.

Remark. All finite sets of rational numbers are commensurate. Add a single irrational number to the set and this new set is incommensurate.

The noise in the present model S of data sets makes the Euclidean algorithm extremely unstable. A noise factor could be arbitrarily small, and dividing by the factor could result in arbitrarily large numbers. A form of the procedure is thus developed based on sorting and subtraction rather than division. Although this requires additional iterations, it is stable with respect to noise.

The following proposition is key to the workings of both the MEA and EQUIMEA. Note: In both algorithms, the GCD is invariant. This is why the algorithms increase the individual signal strengths as the iterations increase.

Proposition 2

gcd(k₁, . . . ,kₙ)=gcd((k₁−k₂),(k₂−k₃), . . . ,(kₙ₋₁−kₙ),kₙ).

Proof. Let α be a positive integer such that α|kⱼ for j=1, . . . , n. Then, α|(kⱼ−kⱼ₊₁) for j=1, . . . , n−1, and α|kₙ. Conversely, assume β is a positive integer such that β|(kⱼ−kⱼ₊₁) for j=1, . . . , n−1, and β|kₙ. Therefore, there exist positive integers c and d such that cβ=kₙ and dβ=(kₙ₋₁−kₙ). Thus, dβ+kₙ=(d+c)β=kₙ₋₁, and so β|kₙ₋₁. By strong induction, β|kⱼ for j=1, . . . , n. Therefore, since the sets {kⱼ} and {(kⱼ−kⱼ₊₁)}∪{kₙ} have the same divisors, gcd(k₁, . . . , kₙ)=gcd((k₁−k₂), (k₂−k₃), . . . , (kₙ₋₁−kₙ), kₙ). Remark. After the first sort and subtract, the gcd of the integers is invariant throughout the remainder of the process.

Accordingly, this procedure is called the Modified Euclidean Algorithm (MEA). It is assumed the sⱼ's are sorted in descending order to allow for a more straightforward visualization of the algorithm, i.e., s₁≥s₂≥ . . . ≥sₙ. (Thus kₙ is the minimum of {kⱼ}.) A new set is formed by subtracting adjacent pairs of these numbers, given by sⱼ−sⱼ₊₁. After this first operation, the phase information has been subtracted out and the resulting set has the simpler form

S′={sⱼ}ⱼ₌₁ⁿ⁻¹, with sⱼ=Kⱼτ+ηⱼ′,

where Kⱼ=kⱼ−kⱼ₊₁ and ηⱼ′=ηⱼ−ηⱼ₊₁. In subsequent iterations of the algorithm, the data maintains this same general form.

Proposition 3 If

γ=gcd((k₁−k₂),(k₂−k₃), . . . ,(kₙ₋₁−kₙ))

then γ|(kⱼ−kₘ) for all j≠m, where 1≤j, m≤n.
Proof. Let γ=gcd((k₁−k₂), (k₂−k₃), . . . , (kₙ₋₁−kₙ)). Assume j=m−l. Then, since γ|(kₘ₋₁−kₘ) for j=1, . . . , n−1, there exist positive integers c and d such that cγ=(kₘ₋₁−kₘ) and dγ=(kₘ₋₂−kₘ₋₁). Adding gives (c+d)γ=(kₘ₋₂−kₘ). Continuing in this fashion l−1 times gives the result.
Remark. In particular, if there exists a prime pᵢ that divides γ, then pᵢ divides (kⱼ−kₙ) for all j, 1≤j≤(n−1).

To deal with the noise, a threshold η₀ is established. After the first sort and subtract (which eliminates the phase ϕ), all numbers in the interval [0,η₀] are declared to be zero and eliminated from the set. Choice of η₀ is dictated by the distribution of the ηⱼ's, with 0<η₀<τ/2. Setting this noise floor parameter η₀ is key. It can be set a variety of ways—a priori, adaptively, or by using a combination of a priori information and adaptive methods (see Subsection 2.4). The present methods sort, subtract adjacent pairs and, after the first iteration, eliminate noise and adjoin the previous non-zero minimum to the set. The algorithm is continued by iterating this process of sorting, subtracting and eliminating the elements in [0, η₀], adjoining the previous non-zero minimum at each new iteration, and will terminate when only a single element remains. Note that Propositions 2 and 3 guarantee that the gcd(K₁, . . . , K₍ₙ₋₁₎) remains unchanged. The lone remaining element is equal to gcd(K₁, . . . , K₍ₙ₋₁₎)·τ±error term.

The Modified Euclidean Algorithm (MEA)

Initialize: Set iter=0.
1.) [Adjoin 0 after first iteration.] If iter>0, then S←S∪{0}.
2.) [Form the new set with elements (sⱼ−sⱼ₊₁).] Set sⱼ←(sⱼ−sⱼ₊₁).
3.) Sort the elements in descending order.
4.) [Eliminate noise.] If 0≤sⱼ≤η₀, then S←S\{sⱼ}.
5.) The algorithm terminates if S has only one element s₁. Declare \hat{τ}=s₁. If not, then set iter←(iter+1). Go to (1.).

Given noise-free data, in Section 3 it is proved that gcd(K₁τ, . . . , K₍ₙ₋₁₎τ)→τ with probability 1 as n→∞.

MEA Simulation Results

Simulations of the algorithm were computed using Python. All estimates and their standard deviations are based on 100-loop Monte-Carlo runs. The number of data samples for a given experiment is given by n (see equation (1)). The low complexity of the MEA leads to computing results quickly.

Without loss of generality, τ=1 is taken in all experiments. This choice is arbitrary, but does allow for a direct visual analysis of the results. Any other fixed real positive number yields similar results. Let \hat{τ} denote the value the algorithm gives for τ, with experimental standard deviations denoted std(\hat{τ}). Choice of initial phase ϕ is also arbitrary as the result is independent of its choice due to the ordering and differencing operations in the algorithm. The noise values ηⱼ are modeled as uniformly distributed with the probability distribution function (pdf)

$${f}_{η} ( η ) ∼ U [ - \frac{Δ}{2} , \frac{Δ}{2} ] ,$$

where U[α, β] denotes the uniform distribution across the interval [α, β]. Then, for example, Δ=2×10⁻¹ implies random phase jitter that is ±10% of the period τ=1. In Table 3 various noise threshold values η₀ were used. It is noted that an increase in the noise floor η₀ had the effect of speeding up the algorithm.

1.) Estimation from Data without Additive Noise.

This example examines the effects that changes in n and in the percentage of missing observations have on the algorithm's performance. The data points have no additive noise i.e., ηⱼ=0 for all j. In this case the algorithm converges to the exact value of τ=1 with standard deviation equal to zero, or, for a small number n, to some multiple of τ.

The missing data elements were modeled as follows. The present methods create jumps in the kⱼ's, which are modeled as uniformly distributed on the (discrete) interval [1,M]. Results are shown in Table 2 (below), which lets % miss denote the experimentally determined average percentage of missing observations and iter denote the average number of iterations required to converge. To interpret these, again the methods visualize the data as zero-crossings of

$$f ( t ) = sin ( \frac{π}{τ} t - ϕ ) .$$

A random process has removed % miss of the zero crossings of ƒ, leaving only n observations.

The top half of Table 2 illustrates the effect of changing M and therefore changing the percentage of missing observations. Given insufficient data, the algorithm may converge to a multiple of τ. Columns labeled τ, 2τ, 3τ, and ≥4τ indicate the percentage of runs that converged to these values. The algorithm is able to choose r correctly based on n=10 data samples, even with 99.99988928% of the possible observations missing. Convergence in the noise-free case depends on n but is independent of M, as shown by the analysis of Section 3. The bottom half of Table 2 illustrates the effect of changing n for M fixed. Reliable results are achieved for n≥10. Note, however, although it is very probable that as few as 10 data elements will produce τ, it is still possible that one could get a multiple of τ. An outlier was found in one simulation, as one can see in the fourth line of the lower table.

TABLE 2
Results from simulating noise-free estimation of τ with the algorithm.

| n | M | % miss | iter | τ | 2τ | 3τ | 3τ | ≥4τ |
|---|---|---|---|---|---|---|---|---|
| 10 | 101 | 88.917 | 7.70 | 100% | 0 | 0 | 0 | 0 |
| 10 | 102 | 98.878 | 47.58 | 100 | 0 | 0 | 0 | 0 |
| 10 | 103 | 99.888 | 436.79 | 100 | 0 | 0 | 0 | 0 |
| 10 | 104 | 99.989 | 2293.16 | 100 | 0 | 0 | 0 | 0 |
| 10 | 105 | 99.999 | 30167.68 | 100 | 0 | 0 | 0 | 0 |
| 4 | 102 | 94.754 | 11.38 | 88% | 6 | 4 | 2 | 0 |
| 6 | 102 | 93.076 | 11.84 | 97 | 3 | 0 | 0 | 0 |
| 8 | 102 | 90.853 | 9.25 | 99 | 1 | 0 | 0 | 0 |
| 10 | 102 | 88.951 | 6.87 | 99 | 1 | 0 | 0 | 0 |
| 12 | 102 | 87.100 | 6.74 | 100 | 0 | 0 | 0 | 0 |
| 14 | 102 | 85.144 | 6.38 | 100 | 0 | 0 | 0 | 0 |

On review of Table 2, a natural question to ask is why the algorithm works so well for 10 or more data elements in S (even with 99.99988928% of the actual elements removed), but breaks down as the number of elements in S is reduced below 10. This is addressed below. In particular, see Theorem 1 and Proposition 4.

2.) Uniformly Distributed Noise.

The present methods may assume that the ηⱼ's have uniform distribution, given by

$${f}_{η} ( η ) ∼ U [ - \frac{Δ}{2} , \frac{Δ}{2} ] .$$

The top half of Table 3 illustrates the effect of increasing M, resulting in more missing observations with fixed noise parameter. Larger M generally requires more data to maintain the same accuracy in \hat{τ} and results in larger std(\hat{τ}). The bottom half shows the effect of increasing noise with n and M fixed.

TABLE 3
Results from estimation of τ from noisy measurements
using the algorithm.

| n | M | Δ | % miss | iter | \hat{τ} | std(\hat{τ}) |
|---|---|---|---|---|---|---|
| 10 | 10¹ | 10⁻³ | 89.123 | 7.31 | 0.9995 | 0.0002 |
| 10 | 10² | 10⁻³ | 97.887 | 7.73 | 0.9980 | 0.0010 |
| 50 | 10³ | 10⁻³ | 99.803 | 11.24 | 0.9973 | 0.0035 |
| 10 | 10¹ | 10⁻³ | 89.13 | 4.31 | 0.9995 | 0.0002 |
| 10 | 10¹ | 10⁻² | 87.94 | 4.45 | 0.9883 | 0.0051 |
| 10 | 10¹ | 10⁻¹ | 88.05 | 4.33 | 0.8857 | 0.0432 |

In consideration of Table 3, a natural question to ask is why \hat{τ} is always less than one. This is discussed below.

The MEA and Order Statistics

The MEA algorithm has an effect on the additive noise in the original data sets. It replaces division, as required in the standard Euclidean algorithm, with repeated subtraction in order to gain stability with respect to this noise. Analysis of this noise is complicated by the facts that the algorithm is iterative and that the algorithm sorts the data. The standard statistical tools used in this type of analysis involves order statistics. Sarhan and Greenberg [45] and Reiss [39] provide the background for discussing this material.

Suppose the probability distribution function (pdf) of the ηⱼ's is given by ƒ_{η}(η) and consider the set of differences obtained in the first iteration, given by

yⱼ=sⱼ−sⱼ₊₁=(kⱼ−kⱼ₊₁)τ+(ηⱼ−ηⱼ₊₁). (2)

Invoking the independent identically distributed (iid) assumption on the ηⱼ's, the pdf of (ηⱼ−ηⱼ₊₁) is given by the convolution ƒ_{η}(η)*ƒₙ(η). So, for example, if

$${f}_{η} ( η ) ∼ U [ - \frac{Δ}{2} , \frac{Δ}{2} ]$$

(η is uniformly distributed with parameter Δ) then ƒ_{y}_{ⱼ}(y)=tri[y−(kⱼ−kⱼ₊₁)τ], the triangle function centered at (kⱼ−kⱼ₊₁)τ. If ƒ_{η} is Gaussian, ƒ_{η}*ƒ_{η} is Gaussian with increased variance.

Two important points are noteworthy. First, after the first iteration, taking the difference of the elements removes the independence of the error terms. Second, by reordering the data, the preset methods make it so that determining the nature of this dependence in subsequent iterations is difficult. Results in order statistics usually assume iid, e.g., see Sarhan and Greenberg [45] and Reiss [39]. Without the iid assumption, this analysis leads into many open questions (see Reiss [39]). These questions about order statistics are deep, and their answers will provide the tools for the analysis of a wide variety of algorithms, including the MEA.

After the first iteration, the pdf of the subsequent error terms becomes asymmetric, even when starting with iid ηⱼ's with symmetric pdf ƒ_{η}(η). The errors are no longer iid because of differencing. It is observed in simulations ([7, 42, 43]) that the algorithm generally leads to negatively biased estimates of τ. This is attributed to the skewness of the pdf of the errors. Preliminary analysis indicates that the noise is settling into a Gnedenko distribution [23]

$${G}_{η} ( η ) ∼ \frac{δ}{{s}_{o}} {η}^{δ - 1} exp ( \frac{- {η}^{δ}}{{s}_{o}} ) , \qquad ( 3 )$$

where s₀ is related to the range of the noise, and δ is a function of both the noise floor and the number of iterations to convergence. As one would expect, more iterations lead to a more skewed distribution. The present methods correct for the skewness by averaging. The data is bined by employing a gradient operator, average across bins, and feed the average values into the MEA (see [7, pp. ^{˜}2264-2267]). This has the effect of greatly increasing the convergence rate of the algorithm and reducing the skewness in the estimate of τ. Other modifications of the MEA can be found in [7, 42, 43, 47].

Subsequent Estimates

Given an estimate \hat{τ} of τ, it is then possible to estimate ϕ and the kⱼ's. The following is a brief discussion of these estimates. Fogel and Gavish [20] have addressed the problem of estimating ϕ, and have produced an estimator \hat{ϕ} for ϕ, given by

$$\hat{ϕ} = \frac{\hat{τ}}{2 π} arg \{ {\sum }_{j = 1}^{n} exp ( 2 π i \frac{{s}_{j}}{\hat{τ}} ) \} . \qquad ( 4 )$$

For a good estimate \hat{τ} of τ,

$$exp ( 2 π i \frac{{k}_{j} τ}{\hat{τ}} ) \approx 1 .$$

For ηⱼ<<τ≈\hat{τ}, ηⱼ/\hat{τ}<<1, and so exp(2πiηⱼ/\hat{τ})≈exp(0)=1. Therefore,

$$\frac{\hat{τ}}{2 π} arg \{ {\sum }_{j = 1}^{n} exp ( 2 π i \frac{{s}_{j}}{\hat{τ}} ) \} = \frac{\hat{τ}}{2 π} arg \{ {\sum }_{j = 1}^{n} exp ( 2 π i \frac{{k}_{j} τ}{\hat{τ}} ) exp ( 2 π i \frac{{η}_{j}}{\hat{τ}} ) exp ( 2 π i \frac{ϕ}{\hat{τ}} ) \} \approx \frac{\hat{τ}}{2 π} arg \{ {\sum }_{j = 1}^{n} exp ( 2 π i \frac{ϕ}{\hat{τ}} ) \} = \frac{\hat{τ}}{2 π} arg \{ n \cdot exp ( 2 π i \frac{ϕ}{\hat{τ}} ) \} = \frac{\hat{τ}}{2 π} ( arg \{ n \} + arg \{ exp ( 2 π i \frac{ϕ}{\hat{τ}} ) \} ) = \frac{\hat{τ}}{2 π} arg \{ exp ( 2 π i \frac{ϕ}{\hat{τ}} ) \} = \frac{\hat{τ}}{2 π} \frac{2 π ϕ}{\hat{τ}} = ϕ . \qquad ( 5 )$$

Next a method of getting an estimate on the set of kⱼ's is presented. Given the estimate \hat{τ}, estimate kⱼ by working with the set

σ′={Kⱼτ+ηⱼ′}ⱼ₌₁ⁿ⁻¹∪{kₙτ+ϕ+ηₙ−\hat{ϕ}}, (6)

where Kⱼ=kⱼ−kⱼ₊₁ and η′ⱼ=ηⱼ−ηⱼ₊₁. Given the estimate \hat{τ}, estimate kₙ by

$${\hat{k}}_{n} = round ( \frac{{k}_{n} τ + ϕ + {η}_{n} - \hat{ϕ}}{\hat{τ}} ) \qquad ( 7 )$$

### and Kⱼ by

$${\hat{K}}_{j} = round ( \frac{{K}_{j} τ + {η}_{j}^{′}}{\hat{τ}} ) \qquad ( 8 )$$

Then, \hat{k}ₙ₋₁=\hat{K}ₙ₋₁+\hat{k}ₙ, \hat{k}ₙ₋₂=\hat{K}ₙ₋₂+kₙ₋₁, and so on.

Estimates of τ, ϕ, and the kⱼ's all give information about the periodic point processes, the generators of the systems, and the noise in the data environment.

Relatively Prime Numbers and the Zeta Function

This section shows that gcd(K₁, . . . , Kₙ₋₁)→1 with probability 1 as n→∞. Convergence is exponentially quick. Therefore, the modified Euclidean algorithm yields either the exact value of τ (when the data is noise-free) or an estimate \hat{τ} (when the data has additive noise). In the noise-free case, the theory shows that the algorithm very likely yields τ given as few as 10 data samples.

This is a manifestation of The Structure of Randomness over [symbol] .
1.) Given n (n≥2) “randomly chosen” positive integers {k₁, . . . , kₙ},

P{gcd(k₁, . . . ,kₙ)=1}→1⁻ quickly as n→∞.
2.) Moreover, the present methods can compute P—
Given n (n≥2) “randomly chosen” positive integers {k₁, . . . , kₙ},

P{gcd(k₁, . . . ,kₙ)=1}=[ζ(n)]⁻¹.

To show this, techniques and results from analytic number theory are needed. Two functions, Riemann's zeta function ζ(z) and the Möbius inversion function μ(m), play key roles. Theorem 1 is classical for the case n=2 and was proven by Dirichlet in 1849 (see Knuth [28, pp. ^{˜}324, 337, 595] and Schroeder [46, pp. ^{˜}48-50]). An elegant formulation for n=2 is given in Hardy and Wright [22]. For n>2, the result was proven by various people [7, 11, 38]. Knuth [28, pg. ^{˜}595] cites a paper of Mertens from 1874 [36]. Nymann does not cite any previous papers, but Cohen [11] says that the result goes back to Mertens and Césaro in the 1870's [11, pg. ^{˜}417].

Let [symbol] denote the complex numbers. Given a complex number z=x+iy, it can be said that x is the real part of z (denoted by x= [symbol] z), and y is the imaginary part of z (denoted by y=ℑz). Riemann's zeta function is defined on the complex half plane {z∈ [symbol] : [symbol] (z)>1} by

ζ(z)=Σₙ₌₁^{∞}n^{-z}. (9)

In 1736, Euler demonstrated the connection of ζ with number theory by showing that

$$ζ ( Z ) = {\prod }_{{p}_{j} ∈ ℙ} \frac{1}{1 - {( {p}_{j} )}^{- z}} \qquad ( 10 )$$

for [symbol] (z)>1, where [symbol] ={p₁, p₂, p₃, . . . }={2, 3, 5, . . . } is the set of all prime numbers (see Conway [12, pp. ^{˜}187-94]). It can be shown that given n (n≥2) “randomly chosen positive integers” {k₁, . . . , kₙ}, the probability that this n-tuple is relatively prime is expressed in terms of the Riemann zeta function.

Pi, the Primes, and Probability

Euler demonstrated

$$ζ ( Z ) = {\prod }_{{p}_{j} ∈ ℙ} \frac{1}{1 - {( {p}_{j} )}^{- z}}$$

for [symbol] (z)>1. In the following P{⋅} denotes probability. The methods make the following result precise, and prove it asymptotically.
Given n (n≥2) “randomly chosen” positive integers {k₁, . . . , kₙ},

P{gcd(k₁, . . . ,kₙ)=1}=[ζ(n)]⁻¹.

Heuristically, it could be argued as follows. Given randomly distributed positive integers, by the Law of Large Numbers, about ½ of them are even, ⅓ of them are multiples of three and 1/p are a multiple of some prime p. Thus, given n independently chosen positive integers,

$$P \{ p \vert {k}_{1} , p \vert {k}_{2} , … , and p \vert {k}_{n} \} =$$

$$( Independence )$$

$$P \{ p \vert {k}_{1} \} \cdot P \{ p \vert {k}_{2} \} \cdot ⋯ \cdot P \{ p \vert {k}_{n} \} =$$

$$1 / ( p ) \cdot 1 / ( p ) \cdot ⋯ \cdot 1 / ( p ) =$$

$$1 / {( p )}^{n} .$$

### Therefore,

P{p [symbol] k₁,p [symbol] k₂, . . . ,and p [symbol] kₙ}=1−1/(p)ⁿ.

Calculating this for all of the primes gives that

P{gcd(k₁, . . . ,kₙ)=1}=Πⱼ₌₁^{∞}1−1/(pⱼ)ⁿ.

where pⱼ is the j^{th} prime. In this last equation, the fact that by the Fundamental Theorem of Arithmetic was used, the prime factor decomposition of any integer kᵢ>1 appears among the prime numbers pⱼ raised to some power. By Euler's formula,

$$ζ ( z ) = {\prod }_{j = 1}^{∞} \frac{1}{1 - {( {p}_{j} )}^{- z}} , ℜ ( z ) > 1 .$$

### Therefore,

P{gcd(k₁, . . . ,kₙ)=1}=1/(ζ(n)).

This heuristic argument breaks down on the first line. Any uniform distribution on the positive integers would have to be identically zero. The merit in the argument lies in the fact that it gives an indication of how the zeta function plays a role in the problem.

Let card{⋅} denote cardinality of the set {⋅}, and let {1, . . . , [symbol] }ⁿ denote the sublattice of positive integers in [symbol] ⁿ with coordinates c such that 1≤c≤ [symbol] . Therefore, Nₙ( [symbol] )=card{(k₁, . . . , kₙ)∈{1, . . . , [symbol] }ⁿ: gcd(k₁, . . . , kₙ)=1} is the number of relatively prime elements in {1, . . . , [symbol] }ⁿ. Let Pₙ( [symbol] ) be the probability that n positive integers chosen at random from {1, . . . , [symbol] } are relatively prime. Then

$${P}_{n} ( ℓ ) = \frac{{N}_{n} ( ℓ )}{{ℓ}^{n}} .$$

The process

$${lim}_{ℓ \to ∞} \frac{{N}_{n} ( ℓ )}{{ℓ}^{n}}$$

is the precise meaning of “randomly chosen” positive integers.

### Theorem 1 Let

Nₙ( [symbol] )=card{(k₁, . . . ,kₙ)∈{1, . . . , [symbol] }ⁿ:gcd(k₁, . . . ,kₙ)=1}. (11)

For n≥2, the methods have that

$${lim}_{ℓ \to ∞} \frac{{N}_{n} ( ℓ )}{{ℓ}^{n}} = {[ ζ ( n ) ]}^{- 1} . \qquad ( 12 )$$

Proof. Begin with the following lemma, which gives a counting formula for Nₙ( [symbol] ) expressed in terms of primes and products of primes. Let └x┘ denote the floor function of x, namely

$$⌊ x ⌋ = {max}_{k \leq x} \{ k : k ∈ ℤ \} .$$

Lemma 1 Let Nₙ( [symbol] )=card{(k₁, . . . , kₙ)∈{1, . . . , [symbol] }ⁿ: gcd(k₁, . . . , kₙ)=1} is the number of relatively prime elements in {1, . . . , [symbol] }ⁿ. Then

$${N}_{n} ( ℓ ) = {ℓ}^{n} - {{Σ}_{{p}_{i}} ( ⌊ \frac{ℓ}{{p}_{i}} ⌋ )}^{n} + {\sum }_{{p}_{i} < {p}_{j}} {( ⌊ \frac{ℓ}{{p}_{i} \cdot {p}_{j}} ⌋ )}^{n} - {\sum }_{{p}_{i} < {p}_{j} < {p}_{k}} {( ⌊ \frac{ℓ}{{p}_{i} \cdot {p}_{j} \cdot {p}_{k}} ⌋ )}^{n} + ⋯ . \qquad ( 13 )$$

Proof of lemma. Choose a prime number pᵢ. The number of integers in {1, . . . , [symbol] } such that pᵢ divides an element of that set is

$$⌊ \frac{ℓ}{{p}_{i}} ⌋ .$$

(Note that is possible to have pᵢ> [symbol] , because

$$⌊ \frac{ℓ}{{p}_{i}} ⌋ = 0 . )$$

Therefore, the number of n-tuples (k₁, . . . , kₙ) contained in the lattice {1, . . . , [symbol] }ⁿ such that pᵢ divides every integer in the n-tuple is

$${( ⌊ \frac{ℓ}{{p}_{i}} ⌋ )}^{n} .$$

Next, if pᵢ·pⱼ divides an integer k, then pᵢ|k and pⱼ|k. Therefore, the number of n-tuples (k₁, . . . , kₙ) contained in the lattice {1, . . . , [symbol] }ⁿ such that pᵢ or pⱼ or their product divide every integer in the n-tuple is

$${( ⌊ \frac{ℓ}{{p}_{i}} ⌋ )}^{n} + {( ⌊ \frac{ℓ}{{p}_{j}} ⌋ )}^{n} - {( ⌊ \frac{ℓ}{{p}_{i} \cdot {p}_{j}} ⌋ )}^{n} ,$$

where the last term is subtracted so that the same numbers are not counted twice (in a simple application of the inclusion-exclusion principle).

Continuing in this fashion, for three integers, say pᵢ<pⱼ<pₖ, the number of n-tuples (k₁, . . . , kₙ) contained in the lattice {1, . . . , [symbol] }n such that pᵢ, pⱼ, or pₖ or any of their products divide every integer in the n-tuple is given by the inclusion-exclusion principle as

$$[ {( ⌊ \frac{ℓ}{{p}_{i}} ⌋ )}^{n} + {( ⌊ \frac{ℓ}{{p}_{j}} ⌋ )}^{n} + {( ⌊ \frac{ℓ}{{p}_{k}} ⌋ )}^{n} ] - [ [ {( ⌊ \frac{ℓ}{{p}_{i} \cdot {p}_{j}} ⌋ )}^{n} - {( ⌊ \frac{ℓ}{{p}_{i} \cdot {p}_{k}} ⌋ )}^{n} ] - {( ⌊ \frac{ℓ}{{p}_{i} \cdot {p}_{j} \cdot {p}_{k}} ⌋ )}^{n} ] .$$

It can therefore be seen by induction that the number of n-tuples (k₁, . . . , kₙ) contained in the lattice {1, . . . , [symbol] }ⁿ such that pᵢ, pⱼ, pₖ, . . . or pₗ or any of their products divide every integer in the n-tuple is given by the inclusion-exclusion principle as

$${Σ}_{{p}_{i}} {( ⌊ \frac{ℓ}{{p}_{i}} ⌋ )}^{n} - {Σ}_{{p}_{i} < {p}_{j}} {( ⌊ \frac{ℓ}{{p}_{i} \cdot {p}_{j}} ⌋ )}^{n} + {Σ}_{{p}_{i} < {p}_{j} < {p}_{k}} {( ⌊ \frac{ℓ}{{p}_{i} \cdot {p}_{j} \cdot {p}_{k}} ⌋ )}^{n} - … .$$

But this counts the complement of Nₙ( [symbol] ) in the lattice {1, . . . , [symbol] }ⁿ. Therefore,

$${N}_{n} ( ℓ ) = {ℓ}^{n} - {Σ}_{{p}_{i}} {( ⌊ \frac{ℓ}{{p}_{i}} ⌋ )}^{n} + {Σ}_{{p}_{i} < {p}_{j}} {( ⌊ \frac{ℓ}{{p}_{i} \cdot {p}_{j}} ⌋ )}^{n} - {Σ}_{{p}_{i} < {p}_{j} < {p}_{k}} {( ⌊ \frac{ℓ}{{p}_{i} \cdot {p}_{j} \cdot {p}_{k}} ⌋ )}^{n} + … .$$

It is now observed that

$$\frac{1}{{ℓ}^{n}} {\sum }_{{p}_{i} < {p}_{j} < … < {p}_{k}} {( ⌊ \frac{ℓ}{{p}_{i} \cdot {p}_{j} \cdot … \cdot {p}_{k}} ⌋ )}^{n} \leq \frac{1}{{ℓ}^{n}} {\sum }_{{p}_{i} < {p}_{j} < … < {p}_{k} \leq ℓ} {( \frac{ℓ}{{p}_{i} \cdot {p}_{j} \cdot … \cdot {p}_{k}} )}^{n} = {\sum }_{{p}_{i} < {p}_{j} < … < {p}_{k} \leq ℓ} {( \frac{1}{{p}_{i} \cdot {p}_{j} \cdot … \cdot {p}_{k}} )}^{n} = {( {\sum }_{p \leq ℓ} \frac{1}{{p}^{n}} )}^{k} \leq {( {\sum }_{p prime} \frac{1}{{p}^{n}} )}^{k} \leq {( {\sum }_{j = 2}^{∞} \frac{1}{{j}^{n}} )}^{k} .$$

Since n≥2, this series is convergent. Thus, each term in the expansion of Nₙ( [symbol] )/ [symbol] ⁿ is convergent. Now, let

$${M}_{k} = {( {\sum }_{j = 2}^{∞} \frac{1}{{j}^{n}} )}^{k} , for k = 0 , 1 , 2 , … .$$

By noting that since n≥2 and the sum is over j∈ [symbol] \{1}, the methods get

$$0 < {Σ}_{j} \frac{1}{{j}^{n}} \leq ( \frac{{π}^{2}}{6} - 1 ) < 1 .$$

Since the k^{th} term in the expansion of Nₙ( [symbol] )/ [symbol] ⁿ is dominated by Mₖ and since

$${Σ}_{k = 0}^{∞} {M}_{k} \leq {Σ}_{k = 0}^{∞} {( \frac{{π}^{2}}{6} - 1 )}^{k} = \frac{6}{( 12 - {π}^{2} )} \qquad ( 15 )$$

is convergent, the series converges absolutely.

The Möbius inversion function μ is now needed, which is defined as follows. Let

$$μ ( 1 ) = 1 , \qquad ( 16 )$$

$$μ ( m ) = \{ \begin{matrix}0 & if m is divisible by the square of a prime , \\ {( - 1 )}^{r} & if m = {p}_{1} \cdot {p}_{2} \cdot … \cdot {p}_{r} , {p}_{1} , {p}_{2} , … , {p}_{r} distinct\end{matrix} .$$

The function μ is called an inversion function because if ƒ is a function defined for all positive integers (an arithmetic function) and F is its sum over all divisors, i.e., F(n)=Σ_{d|n}ƒ(d),
then for all positive integers n, μ inverts ƒ and F by

ƒ(n)=Σ_{d|n}μ(d)F(n/d)

(see Rosen [41, pp. 251-255]). Euler showed that

$$1 - {Σ}_{{p}_{i}} \frac{1}{{p}_{i}^{n}} + {Σ}_{{p}_{i} < {p}_{j}} \frac{1}{{( {p}_{i} \cdot {p}_{j} )}^{n}} - {Σ}_{{p}_{i} < {p}_{j} < {p}_{k}} \frac{1}{{( {p}_{i} \cdot {p}_{j} \cdot {p}_{k} )}^{n}} + … = {Σ}_{m} \frac{μ ( m )}{{m}^{n}} = {[ ζ ( n ) ]}^{- 1} . \qquad ( 17 )$$

where the last sum is over m∈ [symbol] . For n≥2, this series is absolutely convergent. This last equality follows because for j, k, m, n∈ [symbol] ,

$${Σ}_{m} \frac{1}{{m}^{n}} {Σ}_{j} \frac{μ ( j )}{{j}^{n}} = {Σ}_{m , j} \frac{μ ( j )}{{( m j )}^{n}} = {Σ}_{k} \frac{1}{{k}^{n}} {Σ}_{d \vert k} μ ( d ) = 1 , \qquad ( 18 )$$

where the fact is used that both series in the first term converge absolutely and thus can be rearranged in any order (see Leveque [34, p. ^{˜}120]).

Now let ϵ>0 be given. To show that there exists L>0 such that for all [symbol] >L,

$$\vert \frac{{N}_{n} ( ℓ )}{{ℓ}^{n}} - {[ ζ ( n ) ]}^{- 1} \vert < ϵ .$$

By (17), there exists L₁>0 such that for all [symbol] >L₁,

$$\vert [ 1 - {Σ}_{{p}_{i}} \frac{1}{{p}_{i}^{n}} + {Σ}_{{p}_{i} < {p}_{j}} \frac{1}{{( {p}_{i} \cdot {p}_{j} )}^{n}} - {Σ}_{{p}_{i} < {p}_{j} < {p}_{k}} \frac{1}{{( {p}_{i} \cdot {p}_{j} \cdot {p}_{k} )}^{n}} + … ] - {[ ζ ( n ) ]}^{- 1} \vert < \frac{ϵ}{2} . \qquad ( 19 )$$

The fact is used that for all x∈ [symbol] and all n∈ [symbol] , └x┘≤n if and only if x<(n+1). Let

$${P}_{ℓ} = {Σ}_{ℓ < {p}_{i}} \frac{1}{{p}_{i}^{n}} - {Σ}_{ℓ < {p}_{i} < {p}_{j}} \frac{1}{{( {p}_{i} \cdot {p}_{j} )}^{n}} + {Σ}_{ℓ < {p}_{i} < {p}_{j} < {p}_{k}} \frac{1}{{( {p}_{i} \cdot {p}_{j} \cdot {p}_{k} )}^{n}} - … .$$

### Then

$$\vert \frac{{N}_{n} ( ℓ )}{{ℓ}^{n}} - [ 1 - {Σ}_{{p}_{i}} \frac{1}{{p}_{i}^{n}} + {Σ}_{{p}_{i} < {p}_{j}} \frac{1}{{( {p}_{i} \cdot {p}_{j} )}^{n}} - {Σ}_{{p}_{i} < {p}_{j} < {p}_{k}} \frac{1}{{( {p}_{i} \cdot {p}_{j} \cdot {p}_{k} )}^{n}} + … ] \vert \leq \vert {P}_{ℓ} \vert . \qquad ( 20 )$$

### But

$$\vert {P}_{ℓ} \vert \leq {\sum }_{m = ( ℓ + 1 )}^{∞} \frac{1}{{m}^{n}} \leq {\sum }_{m = ( ℓ + 1 )}^{∞} \frac{1}{{m}^{2}} \leq {\sum }_{m = ( ℓ + 1 )}^{∞} \frac{1}{m ( m - 1 )} \leq {\sum }_{m = ( ℓ + 1 )}^{∞} [ \frac{1}{( m - 1 )} - \frac{1}{m} ] = \frac{1}{ℓ} . \qquad ( 21 )$$

Choose L₂ such that for all [symbol] >L₂,

$$\frac{1}{ℓ} < \frac{ϵ}{2} .$$

Let L=max{L₁, L₂}. Then, for all [symbol] >L

$$\vert \frac{{N}_{n} ( ℓ )}{{ℓ}^{n}} - {[ ζ ( n ) ]}^{- 1} \vert = \vert \frac{{N}_{n} ( ℓ )}{{ℓ}^{n}} - [ 1 - {\sum }_{{p}_{i}} \frac{1}{{p}_{i}^{n}} + ... ] + [ 1 - {\sum }_{{p}_{i}} \frac{1}{{p}_{i}^{n}} + ... ] - {[ ζ ( n ) ]}^{- 1} \vert \leq \vert \frac{{N}_{n} ( ℓ )}{{ℓ}^{n}} - [ 1 - {\sum }_{{p}_{i}} \frac{1}{{p}_{i}^{n}} + ... ] \vert + \vert [ 1 - {\sum }_{{p}_{i}} \frac{1}{{p}_{i}^{n}} + ... ] - {[ ζ ( n ) ]}^{- 1} \vert < \frac{ϵ}{2} + \frac{ϵ}{2} = ϵ .$$

This completes the proof of the theorem.

Corollary 1

Let n≥2. Given a randomly chosen n-tuple of positive integers (k₁, . . . , kₙ)∈{1, . . . , [symbol] }ⁿ, the methods have that

$${lim}_{ℓ \to ∞} \frac{{N}_{n} ( ℓ )}{{ℓ}^{n}} = {[ ζ ( n ) ]}^{- 1} .$$

### Thus,

gcd(k₁, . . . ,kₙ)→1,

with probability [ζ(n)]⁻¹ as [symbol] →∞.

Euler gave the amazing result that for k∈ [symbol] ,

$$ζ ( 2 k ) = {\sum }_{n = 1}^{∞} \frac{1}{{n}^{2 k}} = {( - 1 )}^{k + 1} \frac{{( 2 π )}^{2 k}}{2 ( 2 k ) !} {B}_{2 k}$$

where B₂ₖ=2k^{th} Bernoulli Number. (23)
Ireland and Rosen describe this as one of Euler's “most remarkable computations” [24, p. ^{˜}231]. Chapter 3 of Dunham's book Euler: The Master of Us All [13, pp. ^{˜}39-60] and the paper of Ayoub [1] tell the story of these computations.

The exact values of ζ(2k+1), k∈ [symbol] are unknown. However, these values can be estimated, which in turn shows that [ζ(n)]⁻¹→1 quickly as n increases. In fact, the rate of convergence is exponential. This estimate, combined with Theorem 1, explains why as few as 10 data elements are needed to estimate r as demonstrated in Table 2.

TABLE 4
Some values of the Zeta Function ζ(n).

| n | 2 | 4 | 6 | 8 | 10 | 12 | 14 | 16 |
|---|---|---|---|---|---|---|---|---|
| ζ(n) | $\frac{{π}^{2}}{6}$ | $\frac{{π}^{4}}{90}$ | $\frac{{π}^{6}}{945}$ | $\frac{{π}^{8}}{9450}$ | $\frac{{π}^{10}}{93555}$ | $\frac{691 {π}^{12}}{638512875}$ | $\frac{2 {π}^{14}}{18243225}$ | $\frac{3617 {π}^{16}}{325641566250}$ |

Proposition 4 Let ω∈(1, ∞). Then

$${lim}_{ω \to ∞} {[ ζ ( ω ) ]}^{- 1} = 1 , \qquad ( 24 )$$

converging to 1 from below faster than (1−2^{1-ω}).
Proof. Since

ζ(ω)=Σₙ₌₁^{∞}n^{-ω}

and ω>1,

$$1 \leq ζ ( ω ) = 1 + \frac{1}{{2}^{ω}} + \frac{1}{{3}^{ω}} + \frac{1}{{4}^{ω}} + \frac{1}{{5}^{ω}} + ... \leq 1 + \frac{1}{{2}^{ω}} + \frac{1}{{2}^{ω}} + {\underbrace{\frac{1}{{4}^{ω}} + ... + \frac{1}{{4}^{ω}}}}_{4 - times} + {\underbrace{\frac{1}{{8}^{ω}} + ... + \frac{1}{{8}^{ω}}}}_{8 - times} + ... = {\sum }_{k = 0}^{∞} {( \frac{2}{{2}^{ω}} )}^{k} = \frac{1}{1 - \frac{2}{{2}^{ω}}} = \frac{1}{1 - {2}^{1 - ω}} . \qquad ( 25 )$$

### Thus,

(1−2^{1-ω})≤[ζ(ω)]⁻¹<1, (26)

and so

[ζ(ω)]⁻¹→1⁻ as ω→∞

converging to 1 from below faster than (1−2^{1-ω}).
Remark. Thus, given n (n≥2) randomly chosen positive integers {k₁, . . . , kₙ}, the probability that gcd(k₁, . . . , kₙ)→1 quickly as n increases. A good way to think about this is as follows. Given an n-tuple of positive integers that all have the same prime factor, when an integer is added to make an (n+1)-tuple, it is increasingly likely that the new integer does not have this same prime factor.

The primes, as is well-known, do not exhibit any known precise pattern, in that given an arbitrarily large prime pⱼ, the present methods can exactly predict when the next prime pⱼ₊₁ occurs. What is known is an asymptotic estimate for the distribution of the primes. This distribution is given by the well known Prime Number Theorem (see Ireland and Rosen [24, p. ^{˜}2], Rosen [41, p. 71]). If η be a positive real number and if π(η)=the number of primes ≤η, then

$${lim}_{η \to ∞} \frac{π ( η )}{η / log ( η )} = 1.$$

Remark. A positive integer n is square-free if and only if in the prime factorization of n, no prime number occurs more than once. Therefore, a positive integer n is square-free if and only if μ(n) [symbol] 0, where μ denotes the Möbius inversion function. Similarly, k-free numbers can be described as numbers whose prime factorization have the property that no prime number occurs more than k−1 times. The argument above can be modified to count k-free numbers. If Q(n) denotes the number of square-free integers between 1 and n, then

$$Q ( n ) = \frac{n}{ζ ( 2 )} + 𝒪 ( \sqrt{n} ) .$$

The asymptotic density of square-free numbers is therefore

$${lim}_{η \to ∞} \frac{Q ( n )}{n} = \frac{6}{{π}^{2}} = \frac{1}{ζ ( 2 )} .$$

Similarly, the density of k-free numbers is

$$Q ( n , k ) = \frac{n}{ζ ( k )} + 𝒪 ( \sqrt[n]{n} ) ,$$

and has asymptotic density 1/ζ(k).

Recall that, because of the additive phase ϕ, the MEA is actually working with the differences of pairs of the initial data. If it is assumed that n data points with phase information, after the first iteration, the present methods have the data

K₁τ, . . . ,K₍ₙ₋₁₎τ, where Kⱼ=kⱼ−k₍ⱼ₊₁₎,j=1, . . . (n−1).

By Proposition 3, a prime pᵢ divides each kⱼ if and only if pᵢ divides kⱼ−kₙ, j=1, . . . (n−1). Therefore, if the methods let

N₍ₙ₋₁₎( [symbol] ,kₙ)=card{(K₁, . . . ,Kₙ₋₁)∈{(kₙ+1), . . . , [symbol] }ⁿ⁻¹:gcd(K₁, . . . ,Kₙ₋₁)=1},

then note that

N₍ₙ₋₁₎( [symbol] ,kₙ)=card{((k₁−kₙ), . . . )∈{(kₙ+1), . . . , [symbol] }ⁿ⁻¹:gcd(k₁−kₙ, . . . ,k₍ₙ₋₁₎−kₙ))=1}.

This just shifts the point (1, 1, . . . , 1) to the point ((kₙ+1), (kₙ+1), . . . , (kₙ+1)). Therefore, for n≥3, the methods have that

$${lim}_{ℓ \to ∞} \frac{{N}_{( n - 1 )} ( ℓ , {k}_{n} )}{{ℓ}^{n - 1}} = {[ ζ ( n - 1 ) ]}^{- 1} .$$

This shows that

(1−2^{1-ω})≤[ζ(ω)]⁻¹<1, (27)

and so [ζ(ω)]⁻¹→1⁻ as ω→∞ converging to 1 from below faster than (1−2^{1-ω}).

Combining Theorem 1 with Propositions 1 and 3 and inequality (27) shows that the algorithm generates the underlying period τ in the noise-free case as the number of data elements n goes to infinity. Moreover, (27) shows that the algorithm very likely produces this value in the noise-free case with as few as 10 data elements.

Corollary 2 Let n≥3. Given a randomly chosen n-tuple of positive integers (k₁, . . . , kₙ)∈{1, . . . , [symbol] }ⁿ and a fixed positive real number τ,

gcd(K₁τ,τ, . . . ,K₍ₙ₋₁₎τ)→τ,

with probability 1 as n→∞.

Multiple Period Case: The EQUIMEA

This section showns the present methods analysis of multi-period pulse trains and deinterleaving. The goal is to first identify the underlying periods (or “generators”) of data, and then to separate out the data that comes from a given generator. The data model is the union of M copies of previous datasets, each with different periods or “generators” Γ={τᵢ}, different kᵢⱼ's, and different phases ϕᵢ. The data is

S=∪ᵢ₌₁^{M}{ϕᵢ+kᵢⱼτᵢ+ηᵢⱼ}ⱼ₌₁ⁿ^{ᵢ}, (28)

where nᵢ is the number of elements from the i^{th} generator, {kᵢⱼ}, for fixed i, is a linearly increasing sequence of natural numbers with missing observations, ϕᵢ is a random variable uniformly distributed in [0, τᵢ), and the ηᵢⱼ's are zero-mean iid Gaussian with standard deviation 3σᵢⱼ<τᵢ/2. The data are considered as events from M periodic processes. The data, after reindexing and sorting, has the form

S={sₗ}ₗ₌₁^{N}={s₁, . . . ,s_{N}}. (29)

The data will maintain this form throughout the algorithm. It is assumed that for each i, {kᵢⱼ} is a linearly increasing infinite sequence of natural numbers with missing observations such that

kᵢⱼ→∞ as j→∞.

It is assumed that the different periods or “generators” {τᵢ} come from different processes. Therefore, it is assumed that the difference of data elements

(ϕᵢ+kᵢⱼτᵢ+ηᵢⱼ−(ϕ_{i′}+k_{i′j′}τ_{i′}+η_{i′j′}),

for i [symbol] i′, is incommensurate to both τᵢ and τ_{i′} i.e., is not equal to a rational multiple of either number.

The present methods difference as in the MEA, but computes and save all of the differences. The methods repeat this m times, saving the elements from each iteration. A union of all of these data elements is then formed. The relative primeness of data generated by one generator will “fill in” the missing elements for that generator (see Proposition 2), whereas the differenced data from two different generators will become “Weyl flat.”

Assuming only minimal knowledge of the range of {τᵢ}, namely bounds T_{L}, T_{U} such that 0<T_{L}≤τᵢ<T_{U}, the present methods phase wrap the data by the mapping

$${Φ}_{ρ} ( {s}_{l} ) = < \frac{{s}_{l}}{ρ} >= \frac{{s}_{l}}{ρ} - ⌊ \frac{{s}_{l}}{ρ} ⌋ , \qquad ( 30 )$$

where ρ∈[T_{L}, T_{U}), and └⋅┘ is the floor function. Thus <⋅> is the fractional part, and so Φ_{ρ}(sₗ)∈[0,1). Weyl's Theorem applies asymptotically. For almost every choice of ρ (in the sense of Lebesgue measure) Φ_{ρ}(sₗ) is essentially uniformly distributed in the sense of Weyl.

This is a manifestation of The Structure of Randomness over a Continuous Interval [T_{L}, T_{U}).

1.) For almost every choice of ρ (in the sense of Lebesgue measure) Φ_{ρ}(sₗ) is essentially uniformly distributed in the sense of Weyl.

2.) Moreover, the set of ρ's for which this is not true are rational multiples of {τᵢ}. Additionally, since [symbol] is countable (and thus measure zero), these occur (in the sense of {τᵢ}) with probability zero. Therefore, except for those values, Φ_{ρ}(sₗ) is essentially uniformly distributed in [T_{L}, T_{U}). The values at which Φ_{ρ}(sₗ)=0 almost surely are ρ∈{τᵢ/n:n∈ [symbol] }. These values of ρ cluster at zero, but spread out for lower values of n.

Given Sᵢₜₑᵣ={s₁, . . . , s_{N}}, the present methods phase wrap the data by computing modulus of the spectrum, i.e., compute

|Specᵢₜₑᵣ(τ)|=|Σₗ₌₁^{N}e^{(2πis}^{ₗ}^{/τ)}|. (31)

The values of |Specᵢₜₑᵣ(τ)| will have peaks at the periods τⱼ and the harmonics (τⱼ)/k.

Remark. If there were no missing observations, the present methods could proceed as follows. Form the pulse train Σₗ₌₁^{N}δ(τ−sₗ), and then compute the data correlation

[symbol]

(τ)=Σₗ₌₁^{N}Σₘ₌₁^{l}δ(τ−sₗ+sₘ).

Phase wrap the data by computing modulus of the spectrum, i.e., computing

$$\vert {𝒮}_{iter} ( τ ) \vert = \vert {\sum }_{l = 1}^{N} {\sum }_{m = 1}^{n} δ ( τ - {s}_{l} + {s}_{m} ) {e}^{( 2 π i ( \frac{{s}_{l}}{( {s}_{l} - {s}_{m )}} ) )} \vert .$$

The values of | [symbol] ᵢₜₑᵣ(τ)| will have peaks at the periods τⱼ, and not at harmonics. This relies on the following fact. If ω is an nth root of unity not equal to 1, then 1+ω+ . . . +ωⁿ⁻¹=0. Given that there may be missing observations in the data, computing | [symbol] ᵢₜₑᵣ(τ)| will not produce underlying periods.

Weyl's Equidistribution Theorem

The idea of Weyl's Equidistribution Theorem is that given a fixed irrational number γ, the sequence of numbers

<γ>,<2γ>, . . . ,<kγ>, . . .

is essentially uniformly scattered over [0,1). This can be visualized using some tools from topological dynamics. Create a lattice {(m, n), m, n∈ [symbol] ∪{0}} in the upper right hand quadrant in [symbol] ². Now, a ray is drawn starting at (0,0) making an angle φ with the positive x-axis. If φ is a rational number, then the ray intersects a lattice point (m, n) (and infinitely many other lattice points (km, kn), k∈ [symbol] .) However, if φ is irrational, it never intersects with any lattice points, but does come arbitrarily close to infinitely many lattice points. (For example, if φ is the Golden Mean, given any ϵ>0, there are infinitely many pairs of adjacent Fibonacci numbers with ϵ of the ray.) Now, consider the unit square with vertices {(0,0), (1,0), (1,1), (0,1)}. “Glue” the opposite sides together, resulting in a torus [symbol] . If φ is rational, the ray on the torus will be a closed loop. If φ is irrational, the ray never closes. However, given any ϵ>0 and any point t∈ [symbol] , the ray will appear in the ϵ disk around t infinitely often. (In fact, the rate that the ray “fills in” the disk is related to the Diophantine approximation of φ. Very deep work of Katok, Stepin, Margulis et al. [26, 35] addresses this.)

Fourier series play a key role in Weyl's Theorem. The definition, from Dym and McKean [14], follows. Let exp(⋅)=e^{(⋅)} and let [symbol] = [symbol] (mod 2π).

Definition 1 (Fourier Series) Let ƒ be a periodic, integrable function on [symbol] , with period 2Φ, i.e., ƒ∈L¹( [symbol] _{2Φ}). The Fourier coefficients of ƒ, \hat{ƒ}[n], are defined by

$$f [ n ] = \frac{1}{2 Φ} {\int }_{- Φ}^{Φ} f ( t ) exp ( - i π nt / Φ ) dt .$$

If {\hat{ƒ}[n]} is absolutely summable ({\hat{ƒ}[n]}∈l¹), then the Fourier series of ƒ is

ƒ(t)= [symbol] \hat{ƒ}[n]exp(iπnt/Φ).

Once again, let card {⋅} denote the cardinality of {⋅}.

Theorem 2 (Weyl) Given a fixed irrational number γ, then for every a, b such that 0≤a<b<1,

$${lim}_{n \to ∞} \frac{1}{n} card \{ 1 \leq k \leq n : a \leq < k γ > \leq b \} = ( b - a ) . \qquad ( 32 )$$

The theorem is intuitive. Weyl's original proof used techniques and theory from Fourier series. The present method proof follows the development in Körner [30], which follows Weyl's original development.

Proof First prove the following lemma.
Lemma 2 Let γ be a fixed irrational number, and let a, b be real numbers such that 0≤a<b<1. Let ƒ: [symbol] → [symbol] be a continuous function. Then

$${lim}_{n \to ∞} \frac{1}{n} {\sum }_{k = 1}^{n} f ( 2 π k γ ) = \frac{1}{2 π} {\int }_{- π}^{π} f ( t ) dt . \qquad ( 33 )$$

$${lim}_{n \to ∞} \frac{1}{n} card \{ 1 \leq k \leq n : ( 2 π k γ ) ∈ [ 2 π a , 2 π b ] \} = ( b - a ) . \qquad ( 34 )$$

Proof of Lemma. Let

$${G}_{n} ( f ) = \frac{1}{n} {\sum }_{k = 1}^{n} f ( 2 π k γ ) - \frac{1}{2 π} {\int }_{- π}^{π} f ( t ) dt . \qquad ( 35 )$$

It is desired to show that Gₙ(ƒ)→0 as n→∞. Note that

$${G}_{1} ( f ) = \frac{1}{n} {\sum }_{k = 1}^{n} 1 - \frac{1}{2 π} {\int }_{- π}^{π} 1 dt = 0.$$

If t∈[−π, π] and m∈ [symbol] ,

$$\begin{matrix}\vert {G}_{n} ( exp ( imt ) ) \vert = \vert \frac{1}{n} {\sum }_{k = 1}^{n} exp ( 2 π ikm γ ) - \frac{1}{2 π} {\int }_{- π}^{π} exp ( imt ) dt \vert \\ = \vert \frac{1}{n} exp ( 2 π k m γ ) {\sum }_{k = 1}^{n - 1} exp ( 2 π ikm γ ) - 0 \vert \\ = \vert \frac{1}{n} exp ( 2 π k m γ ) [ \frac{1 - exp ( 2 π inm γ )}{1 - exp ( 2 π im γ )} ] \vert \\ \frac{1}{n} \vert [ \frac{1 - exp ( 2 π inm γ )}{1 - exp ( 2 π im γ )} ] \vert \leq \frac{2}{n} \vert [ \frac{1}{1 - exp ( 2 π im γ )} ] \vert\end{matrix} . \qquad ( 36 )$$

Since γ is irrational, 1−exp(2πimγ) is never zero, and so

$$\frac{2}{n} \vert [ \frac{1}{1 - exp ( 2 π im γ )} ] \vert \to 0 as n \to ∞ . \qquad ( 37 )$$

Now, let P(t)=Σₘ₌₋ₗ^{l}aₘ exp(imt) be any trigonometric polynomial. Then by linearity and (36), (37),

Gₙ(P)=Σₘ₌₋ₗ^{l}aₘGₙ(exp(imt))→0 as n→∞. (38)

Now, let g, h: [symbol] → [symbol] be two continuous functions. Let ϵ>0 be given. Assume that

|g(t)−h(t)|<ϵ

for all t∈ [symbol] . Then

$$\vert {G}_{n} ( g ) - {G}_{n} ( h ) \vert \leq \frac{1}{n} {\sum }_{k = 1}^{n} \vert g ( 2 π ikm γ ) - h ( 2 π ikm γ ) \vert + \frac{1}{2 π} {\int }_{- π}^{π} \vert g ( t ) - h ( t ) \vert dt < \frac{1}{n} n ϵ + \frac{1}{2 π} 2 πϵ = ϵ + ϵ = 2 ϵ . \qquad ( 39 )$$

Weierstrass Approximation is now used (see [14, 30]). By Weierstrass, there exists a trigonometric polynomial P(t) such that, given any continuous function ƒ: [symbol] → [symbol] , the methods have

$${sup}_{t ∈ 𝕋} \vert P ( t ) - f ( t ) \vert \leq ϵ / 3.$$

By (38) the methods can find N such that for all n>N,

|Gₙ(P)|<ϵ/3. (40)

Thus, by (39),

|Gₙ(ƒ)−Gₙ(P)|<2ϵ/3. (41)

Therefore, by the triangle inequality, for all n>N,

|Gₙ(ƒ)|≤|Gₙ(P)|+|Gₙ(ƒ)−Gₙ(P)|<ϵ/3+2ϵ/3=ϵ. (42)

To finish, two continuous partitions of unity ƒᵤ and ƒₗ are needed such that ƒᵤ is one on [2πa, 2πb], zero outside of [2πa−ϵ, 2πb+ϵ], and ƒₗ is one on [2πa+ϵ, 2πb−ϵ], zero outside of [2πa, 2πb]. By the computations above, there exits N such that for all n>N,

|Gₙ(ƒᵤ)|<ϵ,|Gₙ(ƒₗ)|<ϵ.

### Thus,

$$\frac{1}{2 π} {\int }_{- π}^{π} {f}_{u} ( t ) dt + ϵ \geq \frac{1}{n} card \{ 1 \leq k \leq n : ( 2 π k γ ) ∈ [ 2 π a , 2 π b ] \} \geq \frac{1}{2 π} {\int }_{- π}^{π} {f}_{l} ( t ) dt - ϵ . \qquad ( 43 )$$

Since ϵ is arbitrary,

$$\frac{1}{n} card \{ 1 \leq k \leq n : ( 2 π k γ ) ∈ [ 2 π a , 2 π b ] \} \to ( b - a ) as n \to ∞ . \qquad ( 44 )$$

This completes the proof of the lemma.

To finish the proof of the theorem, normalize the interval to [0,1).

Remark. If γ is rational, i.e., there exist k∈ [symbol] and n∈ [symbol] such that γ=k/n, then the Weyl Equidistribution Theorem is clearly false. For m∈ [symbol] , the sequence of values <mγ> is a finite set.

Finally for this section, by recalling some basic measure theory. A set X is a set of measure zero if, given any ϵ>0, the set can be covered with open sets of total length less than ϵ. Thus, any finite set {x₁, . . . , xₙ} is of measure zero, can cover it with {(x₁−ϵ/4n, x₁+ϵ/4n), . . . , (xₙ−ϵ/4n, xₙ+ϵ/4n)}. Similarly, any countable set {x₁, . . . , xₙ, . . . } is of measure zero, for it can be covered with {(x₁−ϵ/4, x₁+ϵ/4), . . . , (xₙ−ϵ/4ⁿ, xₙ+ϵ/4ⁿ), . . . }. The set of rationale [symbol] is countable, and therefore of measure zero.

Extending Weyl to Measures

A given element for the present data set has the form ϕᵢ+kᵢⱼτᵢ+ηᵢⱼ. The data elements are then mixed by an iterative process of sorting and subtraction. It is assumed that the different periods or “generators” {τᵢ} come from different processes. Therefore, the present methods can assume that the difference of data elements

(ϕᵢ+kᵢⱼτᵢ+ηᵢⱼ)−(ϕ_{i′}+k_{i′j′}τ_{i′}+η_{i′j′}),

for i [symbol] i′, is incommensurate to both τᵢ and τ_{i′} i.e., is not equal to a rational multiple of either number. The relative primeness of data generated by one generator will “fill in” the missing elements for that generator, whereas the data from two different generators will become “Weyl flat.” Theoretically, if the present methods are allowed to go on indefinitely, it would become ergodic, with the sets of differences from different generators becoming a set of full measure, while the set of differences from the same generator remaining as a set of measure zero. Background for this section includes Blum and Mizel [3], Breiman [5], and Walters [48]. In particular, this discussion is based, in part, Chapter 6 of Breiman [5] and Chapters 1-4 of Walters [48].

Recall that a probability space consists of a set X, a collection [symbol] of Borel subsets of X, and P an additive measure normalized so that P(X)=1.

Definition 2 Suppose that (X₁, [symbol] , P₁) and (X₂, [symbol] ₂, P₂) are probability spaces.
(a.) A transformation T: X₁→X₂ is measurable if

B₂∈ [symbol] ₂⇒T⁻¹(B₂)∈ [symbol] ₁.
(b.) A transformation T: X₁→X₂ is measure-preserving if T is measurable and

P₁(T⁻¹(B₂))=P₁(T⁻¹(B₂)) for all B₂∈ [symbol] ₁.

The term ergodic is an amalgamation of Greek words ergon (work) and odos (path). It was first used by Boltzmann to describe the action T_{φ}(t): t∈ [symbol] : on an energy surface. A discussion of the path of the ray on the torus [symbol] is relevant. The intuition is that the present methods have an ergodic process if φ is irrational and do not have one if φ is rational.

Definition 3 Let (X, [symbol] , P) be a probability space. A measure preserving transformation T of (X, [symbol] , P) is called ergodic if the only members B of [symbol] with the property that T⁻¹(B)=B satisfy P(B)=0 or P(B)=1.
Definition 4 A sequence of real random variables {xⱼ}⊂[0,1) is essentially uniformly distributed in the sense of Weyl if given a, b, 0≤a<b<1,

$$\frac{1}{n} card \{ 1 \leq j \leq n : {x}_{j} ∈ [ a , b ] \} \to ( b - a ) as n \to ∞ almost surely .$$

For the present variation of Weyl's Theorem, it is assumed that for each i, {kᵢⱼ} is a linearly increasing infinite sequence of natural numbers with missing observations such that kᵢⱼ→∞ as j→∞. The present methods must make this assumption because the result is only approximately true for a finite length sequence.

Theorem 3 For almost every choice of ρ (in the sense of Lebesgue measure) Φ_{ρ} (sₗ) is essentially uniformly distributed in the sense of Weyl.

Proof Let ρ∈[T_{L},T_{U}], └⋅┘ be the floor function, and <⋅> be the fractional part. The mapping

$${Φ}_{ρ} ( {s}_{l} ) = 〈 \frac{{s}_{l}}{ρ} 〉 = \frac{{s}_{l}}{ρ} - ⌊ \frac{{s}_{l}}{ρ} ⌋ ,$$

is a measurable and measure-preserving mapping into [0,1).
Claim. For a.e. choice of ρ, Φ_{ρ} is ergodic.
Proof of Claim. Normalize [T_{L},T_{U}) to [0,1) Let X be a square integrable random variable. Thus, X can be expanded in a Fourier series

X(t)= [symbol] \hat{X}[n]exp(iπnt). (45)

Then

X(Φ_{ρ}(t))= [symbol] \hat{X}[n]exp(iπnt/ρ). (46)

For X to be invariant,

cₙ(1−exp(iπnt/ρ))=0 for all n.

This implies either

cₙ=0 or exp(iπnt/ρ)=1.

But since ρ is irrational a.e., the latter is false on a set of full measure.

Additionally, the set of ρ's for which this is not true are rational multiples of {τᵢ}. These are a set of measure zero. Therefore, except for those values, Φ_{ρ}(αᵢⱼ) is essentially uniformly distributed in [0,1). The values at which Φ_{ρ}(sₗ)=0 almost surely are

$$ρ ∈ \{ \frac{{τ}_{i}}{n} : n ∈ ℕ \} ,$$

which is a set of measure zero.

The EQUIMEA

The EQUIMEA algorithm is built upon the MEA, relying on the MEA procedure to “reinforce” or “fill in” data elements from a given fixed generator. It then uses Theorem 3 to separate out differenced elements from different generators. The present methods difference as in the MEA (see Steps 1.)-4.) of the algorithm), but compute and save all of the differences. The present methods repeat this m times, saving the elements from each iteration. The present methods form a union of all of these data elements (see Step 5.). The relative primeness of data generated by one generator will “fill in” the missing elements for that generator (see Proposition 2). In contrast, the differenced data from two or more different generators will become “Weyl flat.” A Wiener periodogram and Theorem 3 are relied upon to sift out the data from a given fixed generator from the differenced data from two or more different generators (see Steps 6.)-11.)).

The “noise-like” behavior of Φ_{ρ}(sₗ) for a. e. ρ leads to a “flat” range [0,η₀] for S for

ρ [symbol] {τᵢ/n:n∈ [symbol] }.

Given the need to produce an answer in finite time, and therefore, have to terminate, a pre-set a noise floor no is set and two degree of accuracy parameters, ε_{β} and ε_{η}. The first, ε_{β}, sets a “Weyl noise floor,” while ε_{η} sets an iterative convergence baseline. The number of times that this process is applied is related to η₀, ε_{β} and ε_{η}. The data is sorted, giving

Sᵢₜₑᵣ={sₗ}ₗ₌₁^{N}={s₁, . . . ,s_{N}}.

The data is phase wrapped by computing modulus of the spectrum, i.e., compute

|Specᵢₜₑᵣ(τ)|=|Σₗ₌₁^{N}e^{(2πis}^{ₗ}^{/τ)}|.

The values of |Specᵢₜₑᵣ(τ)| will have peaks at the periods τᵢ and their harmonics (τᵢ)/k.

Given |Specᵢₜₑᵣ(τ)|, choose the rightmost peak. Label it as τᵢₜₑᵣ. The parameter ε_{η} is used as a difference between iterations. If

|τᵢₜₑᵣ−τᵢₜₑᵣ₋₁|<ε_{η}, (47)

declare [symbol] =τᵢₜₑᵣ.

The parameter ε_{β} is more complicated (A variation, with analysis, for setting ε_{β} in certain cases is given in [37]. Their model, however, assumes no missing observations). It is a type of a “spectral envelop,” but only requires the data from the first iteration S₁={sₗ}ₗ₌₁^{N}. It is assumed a priori that the periods {τᵢ} lie in a range [T_{L},T_{U}). Let T=T_{U}−T_{L}. Given N data points, think of the data in N “bins” of width T/N. For each of these bins, the present methods can compute the correlation and the spectrum of the data elements in the K^{th} bin. Let this data be represented as

S_{K}={s₁,s₂, . . . ,S_{N}_{_{K}}}.

From the pulse train

Σₗ₌₁^{N}^{_{K}}δ(τ−sₗ),

compute the data correlation

[symbol]

_{K}(τ)=Σₗ₌₁^{N}^{_{K}}Σₘ₌₁^{l}δ(τ−sₗ+sₘ)

and the modulus of the spectrum, i.e., computing

$$\vert {𝒮}_{K} ( τ ) \vert = \vert {\sum }_{l = 1}^{{N}_{K}} {\sum }_{m = 1}^{l} {e}^{( 2 π i ( \frac{{s}_{l}}{( {s}_{l} - {s}_{m} )} ) )} \vert .$$

for sₗ in the K^{th} bin. Then

ε_{β}=max{ [symbol] _{K}, [symbol] _{K}}.

Given the rightmost peak, which is labeled as τᵢₜₑᵣ, if

|Specᵢₜₑᵣ(τᵢₜₑᵣ)|>ε_{β}, (48)

declare [symbol] =τᵢₜₑᵣ. The values are functions of the percentage of missing observations, the jitter noise model, and the percentage of the jitter noise. Numerical experiments have shown that given a reasonable percentage of observations and noise, ε_{β} is an effective stopping parameter. These values are to be determined a priori for a given data set or determined experimentally.

The EQUIMEA Algorithm—Multiple Periods

Initialize: Sort the elements of S in descending order. Form the new set with elements (sₗ−sₗ₊₁). Set sₗ←(sₗ−sₗ₊₁). Set iter=1, i=1, η₀, ε_{R}, and ε_{η}.
1.) [Adjoin 0.] Sᵢₜₑᵣ←S∪{0}.
2.) [Sort.] Sort the elements of Sᵢₜₑᵣ in descending order.
3.) [Compute all differences.] Set Sᵢₜₑᵣ=∪(sⱼ−sₖ) with sⱼ>sₖ.
4.) [Eliminate noise.] If 0≤sⱼ≤η₀, then S←S\{sⱼ}.
5.) [Adjoin previous iteration.] Form Sᵢₜₑᵣ←Sᵢₜₑᵣ∪Sᵢₜₑᵣ₋₁, sort and reindex.
6.) [Compute spectrum.] Compute |Specᵢₜₑᵣ(τ)|=|Σₗ₌₁^{N}e^{(2πis}^{ₗ}^{/τ)}|.
7.) [Threshold.] Choose the rightmost peak. Label it as τᵢₜₑᵣ.
8.) If |Specᵢₜₑᵣ(τᵢₜₑᵣ)|>ε_{β} or |τᵢₜₑᵣ−τᵢₜₑᵣ₋₁|<ε_{η}, declare [symbol] =τᵢₜₑᵣ.
If not, iter←(iter+1). Go to 1.).
9.) Given τᵢ, remove it and its harmonics |Specᵢₜₑᵣ(τ)| for [symbol] /m, m∈ [symbol] . Label as Notchᵢₜₑᵣ(τ).
10.) [Recompute frequency notched spectrum.] Compute |Specᵢₜₑᵣ(τ)−Notchᵢₜₑᵣ(τ)|.
11.) [Threshold.] If |Specᵢₜₑᵣ(τ)−Notchᵢₜₑᵣ(τ)|≤ε_{β} algorithm terminates. Else, let i←i+1.
Go to step 7.).

Next the present methods need to deinterleave the data. A standard discrete matched filtering algorithm is used, correlating a known delayed signal with an unknown signal to detect the presence of the template in the unknown signal. Here, an known signal has the form

[symbol]

δ(t−kτᵢ),

a pulse train of period τᵢ with no missing observations, and the unknown signal consists of those elements of the original data S generated by τᵢ.

Given the original data and the set of generating periods {τ₁, . . . , τₙ}, convolve the data with

[symbol]

δ(t−kτ₁).

This convolution will identify the elements in the original data set S that are generated by the generating period τ₁. Call these elements S_{τ}_{₁}. Let S₂=S\S_{τ}_{₁}. Convolve S₂ with

[symbol]

δ(t−kτ₂).

This convolution will identify the elements in the data set S₂ that are generated by the generating period τ₂. Call these elements S_{τ}_{₂}. Let S₃=S\S_{τ}_{₂}. Repeat the process for τ₃ up to τₙ.

This process deinterleaves the data into components generated by individual generators τᵢ. Further analysis can be carried out on these individual components.

EQUIMEA Simulation Results

Analysis of four data sets. The first had a single periodic generator, the second, two generators, and the third, three generators. All of these were sparse data sets, with ≈90% missing data elements. The EQUIMEA algorithm is used to isolate the periodicities in the data. The data sets were noisy (10% jitter error). In the first three data sets, 90% of the information was randomly removed. The error, but especially the sparsity of the data, rendered the usual tools, e.g., Wiener's periodogram, useless. Once the periods were isolated, the present methods used convolution-matched filtering algorithms to deinterleave the data sets. The fourth data set had two generators, but was extremely sparse, with ≈99% missing data elements.

The data in FIG. 1 had one underlying period, equaling 1, with 90% of the information randomly removed, and 10% jitter noise. FIG. 2 shows |Specᵢₜₑᵣ| after three iterations. The period is clearly visible as the rightmost peak. Recall that, given a fixed data set S, the period of that data set is the unique maximum value of τ such that the kⱼ are all integers. Note that for any period τᵢ which fits the form of S, the numbers

$$\frac{{τ}_{i}}{2} , \frac{{τ}_{i}}{3} , …$$

are also possible values. Thus, what one sees in all of the spectral outputs are peaks at the values τᵢ,

$$\frac{{τ}_{i}}{2} , \frac{{τ}_{i}}{3} , ... .$$

This explains the need for the following steps in the EQUIMEA algorithm:
7.) [Threshold.] Choose the rightmost peak. Label it as τᵢₜₑᵣ
8.) If |Specᵢₜₑᵣ(τᵢₜₑᵣ)|>ε_{β} or |τᵢₜₑᵣ−τᵢₜₑᵣ₋₁|<ε_{η}, declare [symbol] =τᵢₜₑᵣ.
If not, iter←(iter+1). Go to 1.).
9.) Given τᵢ, remove it and its harmonics |Specᵢₜₑᵣ(τ)| for [symbol] /m, m∈ [symbol] . Let i←i+1.

Also note the EQUIMEA algorithm can extract the period from extremely sparse data (90% of the information randomly removed, and 10% jitter noise—FIG. 1), and tell us, after the “frequency notching step,” that there is only one period in the data set (FIG. 2). See, e.g. FIG. 1: One Period Original Data and FIG. 2: One Period EQUlter3 Spectrum. In FIG. 2, note the sharp peaks as a result of the provided filtering bounds. The sharp peaks allow for subsequent analyses.

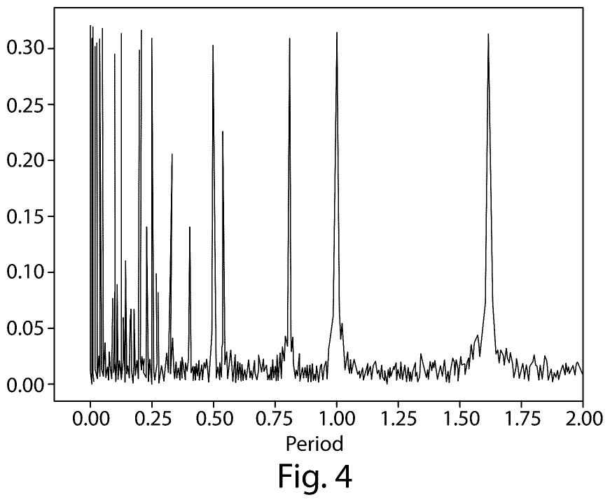

The data in FIG. 3 had two underlying periods equaling 1 and φ=(1+\sqrt{5})/2, with 90% of the information randomly removed and 10% jitter noise. FIG. 4 shows |Specᵢₜₑᵣ| after two iterations. By proceeding right to left, one can easily see the two underlying periods

$$- \frac{1 + \sqrt{5}}{2}$$

and 1. one can then deinterleave each separate periodic process from the original by convolving with the individual pulse trains

$${\sum }_{k ∈ ℤ} δ ( t - k \frac{1 + \sqrt{5}}{2} ) , and {\sum }_{k ∈ ℤ} δ ( t - k ) .$$

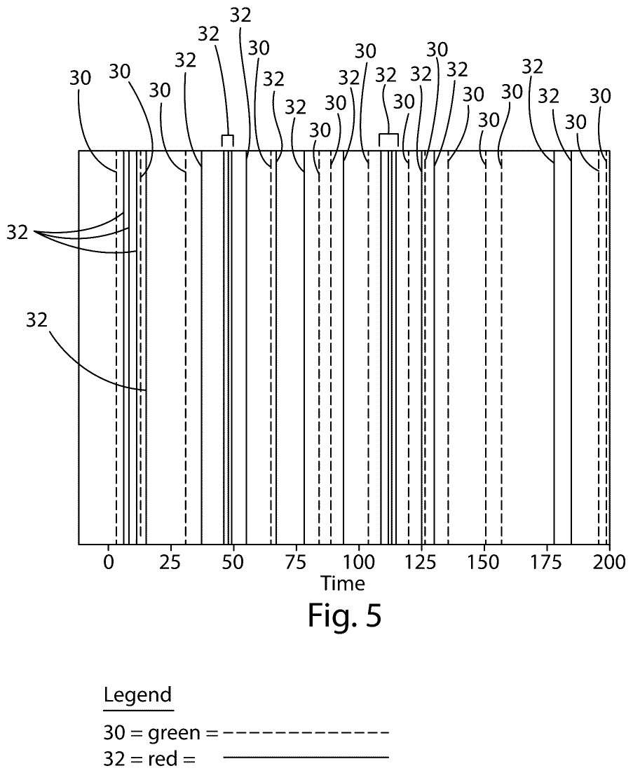

Each will reinforce the data elements from the specific generator, allowing the elements to be extracted. FIG. 5 shows the data deinterleaved, which can be demarked by color, line patterns and the like. For example, as shown one period is shown by green or dashed lines 30 and another period shown by red or solid lines 32. The solid line 32 (red) elements were generated by 1, the dashed 30 (green) elements by

$$\frac{1 + \sqrt{5}}{2} .$$

See, e.g., FIG. 3: Two Periods Original Data; FIG. 4: Two Periods EQUlter2 Spectrum, and FIG. 5: Two Periods Deinterleaved. Again note the sharp peaks on FIG. 4 which due to the EQUIMEA analysis allows for deinterleaving as shown in FIG. 5.

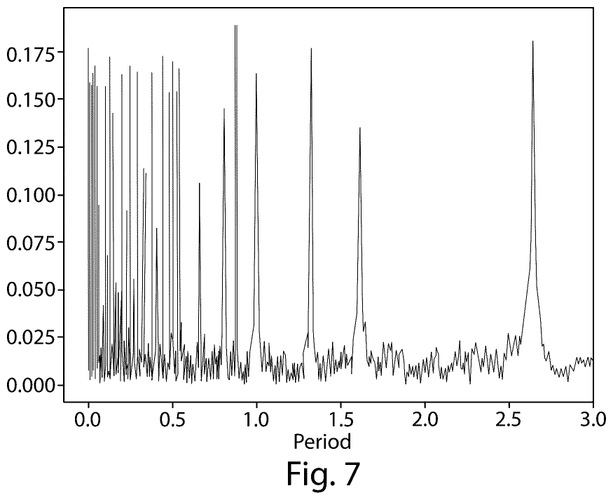

The data in FIG. 6 had three underlying periods equaling 1, φ=(1+\sqrt{5})/2, \sqrt{7}, with 90% of the information randomly removed, and 10% jitter noise. FIG. 7 shows |Specᵢₜₑᵣ| after two iterations. By proceeding right to left, one can easily see the three underlying periods—\sqrt{7},

$$\frac{1 + \sqrt{5}}{2} ,$$

and 1. (“Frequency notching” eliminates the first harmonic peak of \sqrt{7}, located at \sqrt{7}/2, and so the peak at 1 stands out.) (See harmonics 70 of FIG. 7) One can then deinterleave each separate periodic process from the original by convolving with the individual pulse trains

$${\sum }_{k ∈ ℤ} δ ( t - k \sqrt{7} ) , and {\sum }_{k ∈ ℤ} δ ( t - k ( \frac{1 + \sqrt{5}}{2} ) ) , and {\sum }_{k ∈ ℤ} δ ( t - k ) .$$

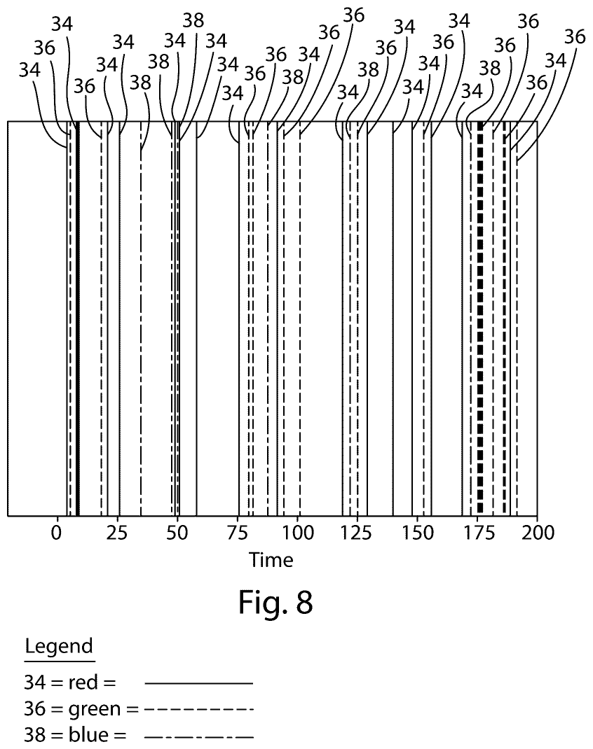

Each will reinforce the data elements from the specific generator, allowing the elements to be extracted. FIG. 8 shows the data interleaved, and may be demarked by color or line patterns. The solind line 34 (red) elements were generated by 1, the dashed line 36 (green) elements by

$$\frac{1 + \sqrt{5}}{2} ,$$

and the broken dashed lines 38 (blue) elements by \sqrt{7}. See, e.g., FIG. 6: Three Periods Original Data; FIG. 7: Three Periods EQUlter2 Spectrum; and FIG. 8: Three Periods Deinterleaved.

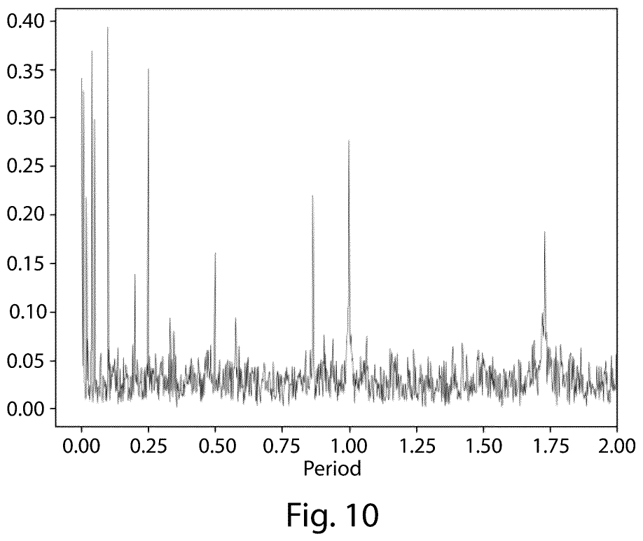

The final example is an extremely sparse data set, with 99% of the information randomly removed and 10% jitter noise. The data in FIG. 9 had two underlying periods equaling 1 and \sqrt{3}. FIG. 10 shows |Specᵢₜₑᵣ| after two iterations. By proceeding right to left, one can easily see the two underlying periods—\sqrt{3} and 1. One can then deinterleave each separate periodic process from the original by convolving with the individual pulse trains

[symbol]

δ(t−k\sqrt{3}), and [symbol] δ(t−k).

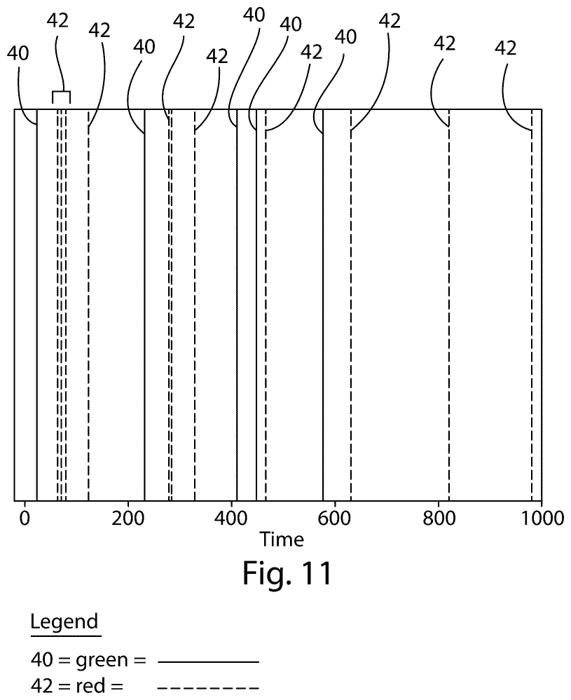

Each will reinforce the data elements from the specific generator, allowing the elements to be extracted. FIG. 11 shows the data deinterleaved, demarked by color. The dashed line 42 (red) elements were generated by 1, the solid line 40 (green) elements by \sqrt{3}. See, e.g. FIG. 9: Sparse Two Period; FIG. 10: Sparse Two Period Spectrum; and FIG. 11: Sparse Two Period Deinterleaved.

The EQUIMEA is reliant on the “incommensurate nature” of the periods to each other. This manifests itself in the difference of data elements

(ϕᵢ+kᵢⱼτᵢ+ηᵢⱼ)−(ϕ_{i′}+k_{i′j′}τ_{i′}+η_{i′j′}),

for i [symbol] i′, is incommensurate to both τᵢ and τᵢ, i.e., is not equal to a rational multiple of either number.

This brings up two points. If two underlying processes have commensurate (or even equal) periods, the EQUIMEA will first capture the largest of the periods (or the period). It is probable that the two or more events will not have the same phase. This data will then be separated by the deinterleaving process.

The second point is more subtle, and leads to a discussion of computability. Compare the outputs of |Specᵢₜₑᵣ| for the second and fourth data sets. For both data sets, the generators are incommensurate, and so the difference of data elements

(ϕᵢ+kᵢⱼτᵢ+ηᵢⱼ)−(ϕ_{i′}+k_{i′j′}τ_{i′}+η_{i′j′}),

for i [symbol] i′, is incommensurate to both τᵢ and τ_{i′}. These data elements in |Specᵢₜₑᵣ| become “Weyl flat.” But this is a function of the degree of the accuracy of the computation, the ergodicity of the periods relative each other, and, if applicable, to Diophantine approximation. Again it is noted that very deep work of Katok, Stepin, Margulis et al. [26, 35] addresses this.

Results on Fibonacci numbers and the Golden Mean φ.

Lemma 3 (Fibonacci and $$) Let [symbol] ₁= [symbol] ₂=1, [symbol] ₙ₊₁= [symbol] ₙ+ [symbol] ₙ₋₁, the Fibonacci numbers, and φ=(1+\sqrt{5})/2. Then φ=[1, 1, 1, 1, . . . ],

$$φ = 1 + \frac{1}{1 + \frac{1}{1 + \frac{1}{1 + ...}}}$$

$$and$$

$${lim}_{n \to ∞} {ℱ}_{n + 1} / {ℱ}_{n} = φ .$$

Thus, given any ϵ>0, there exists infinitely many Fibonacci numbers such that | [symbol] ₙ₊₁− [symbol] ₙφ|<ϵ.

The data in FIG. 3 had two underlying periods equaling 1 and φ=(1+\sqrt{5})/2, with 90% of the information randomly removed and 10% jitter noise. FIG. 4 shows |Specᵢₜₑᵣ| after two iterations. By proceeding right to left, one can easily see the two underlying periods

$$- \frac{1 + \sqrt{5}}{2}$$

and 1. One can then deinterleave each separate periodic process from the original by convolving with the individual pulse trains

$${\sum }_{k ∈ ℤ} δ ( t - k \frac{1 + \sqrt{5}}{2} ) , and {\sum }_{k ∈ ℤ} δ ( t - k ) .$$

Each will reinforce the data elements from the specific generator, allowing the elements to be extracted. FIG. 5 shows the data deinterleaved, demarked by color. The red elements were generated by 1, the green by

$$\frac{1 + \sqrt{5}}{2} .$$

The algorithm “backfilled” the multiples of

$$\frac{1 + \sqrt{5}}{2}$$

and 1, while the data from two different periods will became “Weyl flat.”

In the last example, although \sqrt{3}=[1, 1, 2, 1, 2, . . . ], a Diophantine approximation on the order of φ, the present methods do not have enough data in this last data set for the incommensurate data elements in |Specᵢₜₑᵣ| to become as “Weyl flat” as they do in, say, FIG. 4.

There is always a tradeoff between the amount of the data, the signal-to-noise ratio, and the efficiency of a given procedure. With the EQUIMEA, the additional complexity of the level of incommensurability between the periods as determined by, say, Diophantine approximation, plays a role. This then gets into the accuracy of the numerical representations. Looking into the performance of the EQUIMEA for data generated by

$$φ = \frac{1 + \sqrt{5}}{2}$$

and 1 in comparison with data generated by

$$ψ = \sum \frac{1}{10 !}$$

and 1; here, φ, the Golden Mean, is poorly approximated by rationals, whereas ψ is a Liouville number, a transcendental well approximated by rationals. In terms of their approximation by rationals, φ and ψ are quite different. |Specᵢₜₑᵣ| will become “Weyl flat” more quickly for φ than ψ.

### Applications

Radar and Sonar

Once the present methods have provided the analysis of the datasets as described above the results can be inputted into various applications.

For example, the EQUIMEA gives an efficient method to analyse radar and sonar signals, and, in the case of multiple signals, to deinterleave the signals. It assumes no a prioiri assumptions on the signals, nor any additional data other than Time of Arrival (TOA). Clearly, with additional information, the information can be refined. Surveying, none of these can work in sparse signal environment that the EQUIMEA can work. Again, because of the MEA engine (the GCD is invariant), the algorithm increases the individual signal strengths as the iterations increase.

Many concentrate on denoising. The EQUIMEA, by means of it data reinforcement both reinforces the signal strength and robustifies the signal relative the noise. The EQUIMEA is based on the structure of the data.

Other methods use automata, neural nets, continuous recalibration, matched filtering, frequency tagging, and the like. For example, cf [37] Nishiguchi, K., and Kobayashi, M., Improved algorithm for estimating pulse repetition intervals, IEEE Transactions on Aerospace and Electronic Systems, 36 (2), 408-421 (2000).

However, [37] can not handle even a single missing data point, only moderate noise, and they do not interleave. Moreover, they do not explain why the algorithms work. They don't understand the key role Weyl's Equidistribution Theorem plays is making the procedure work.

Frequency-Hopping Spread-Spectrum (FHSS) Radio Technology

The present methods and algorithms are extremely effective tools for analyzing a very specific set of signals—for example hop times of frequency-hopping radios. Frequency-hopping spread-spectrum (FHSS) radio technology is a wireless technology that spreads signals over rapidly changing frequencies. Each available frequency band is divided into subfrequencies. Signals rapidly change, or “hop,” among these subfrequency bands in a pre-determined order. The actual messages are broken into segments. These segments are sent in these frequency hops, and then re-assembled by the receiver. FHSS has advantages over a fixed-frequency transmission:
FHSS signals are highly resistant to narrowband interference because the signal hops to a different frequency band.
Signals are difficult to intercept if the frequency-hopping pattern is not known.
FHSS transmissions can share a frequency band with many types of conventional transmissions with minimal mutual interference. FHSS signals add minimal interference to narrowband communications, and vice versa.
Spread-spectrum signals are highly resistant to deliberate jamming, unless the adversary has knowledge of the frequency-hopping pattern.

The underlying hop timing of the FHSS signal from covertly extracted Fourier data gathered from the signal environment in which FHSS radios were transmitting were examined. The solution was the first of the two algorithms. This allowed the identification of the frequency-hopping pattern, which then lead to the analysis and classification of the this pattern. Moreover, this in turn allowed for the analysis of the shift-register generated hop sequences, thus providing additional useful information of FHSS data. The first algorithm works on single communication FHSS environments, the second and more recent algorithm is a breakthrough on multiple communication FHSS environments.

Extremely fast acousto-optic devices (Acousto-optic or Bragg cell systems) computed a windowed discrete Fourier transform of the signal environment. From this, a data set could be extracted which contained the measurements of the FHSS carrier frequencies. The sequence of hop times were realized as (extremely noisy and sparse) changes of location in frequency space. Buried in all of this information was the signature—the fundamental clock cycle—that would allow the carrier frequencies to be tracked, which in turn made it possible to listen to the message. The first and most fundamental problem in analyzing information from the hopping radios was to extract this fundamental clock cycle. It was embedded in the sequence of frequency hop times, which were strictly increasing, seemingly random, but were generated by a periodic process. Solving the problem of extracting this fundamental unit required the algorithm. The first algorithm extracts the underlying hop period of the radios, even in the case of extremely sparse and noisy data.

Determining the underlying hop timing answers two important questions about a given FHSS signal.
First, it helps identify the radios. Radios from different manufacturers generally have different underlying clock cycles. Put simply, it answers the question “Friend or foe?”
The second is that it gives a predictor for when the radio will hop.

Part of the acousto-optic system mentioned above was a signal splitter, with one channel going into a signal delay. This allowed, among other things, a set of markers at the clock cycles of the jumps to be placed. If a frequency change occurred near or at a marker, then it was flagged as a jump. These markers were incorporated into the delayed signal.

This then allowed the system to retune and capture the actual message from the delayed signal environment.

Moreover, if a signal got lost for a short while, and a jump occurred at a marker, it was recaptured. (Once several frequency hops were detected matching the given time signatures, a given signal was then reacquired.) Frequency hops were matched in the delayed signal, and the actual FHSS message was recorded.

The first procedure is called the MEA (The names for the algorithms becomes obvious when one understands their underlying mechanisms.), and it is a very efficient algorithm for extracting the fundamental period (the generator) from a set of sparse and noisy observations of a periodic process. Given that the data is time of arrival or, more accurately, time of occurrence, the noise is jitter noise, a variation around the exact location of the event. Noise is modeled as an additive random variable. The MEA works on all single generator periodic point processes, but in particular, when the standard tools break down. The procedure is computationally straightforward, stable with respect to noise and converges quickly. Variations on equidistribution theory lead to a second algorithm (the EQUIMEA) for several classes of problems in periodic parameter estimation. The second algorithm is also general and very efficient, and can be applied to the deinterleaving and analysis of processes with multiple generators.

In the case of a single generator, the MEA algorithm uses the theory of numbers in novel ways to extract the underlying period by modifying the Euclidean algorithm to determine the period from a sparse set of noisy measurements [6, 7, 42, 43]. The key thing to note in the sample data sets is the sparseness of the data. The elements are the noisy occurrence times of a periodic event with missing measurements. Think of the data elements as the zero crossings of a sinusoid. If the methods have all or nearly all of those zero crossings, least squares will lead to recovering the period, even in a relatively noisy environment. However, say that a random process has removed more and more of these zero crossings. Other methods break down. These issues are discussed in [6, 7, 9, 10], and detailed comparisons are given in [7, 43]. In particular, the paper [43] gives a very thorough analysis of comparing the MEA algorithm to other methods. Given even 25% missing data, the MEA method was superior, and worked in situations (≥50% missing data) where other methods did not produce meaningful results.

The EQUIMEA addresses the analysis of multi-period pulse trains and deinterleaving. The goal is to first identify the underlying periods (or “generators”) of data, and then to separate out the data that comes from a given generator. The present model is the union of M copies of previous datasets, each with different periods or “generators” is the deinterleaving procedure, the EQUIMEA. It needs to be pointed out that the “engine” for the EQUIMEA is the MEA, and that the second algorithm derives much of its efficiency from the first. (See, e.g., Novel Techniques for Signal Analysis and Processing SD Casey—2021—community.apan.org . . . fixed-frequency transmission: FHSS signals are . . . FHSS transmissions can share a frequency band with many types of conventional transmissions with minimal mutual interference. FHSS . . . )

Medical Applications

In a sparse signal environment that the EQUIMEA can work, e.g., in birth of twins and stress. The MEA/EQUIMEA algorithms are extremely computationally efficient. This makes them useful for a lot of potential medical data analyses. For example, in the birthing process, both the mothers and the baby's (babies') heartbeats are closely monitored. A rapid change in heartbeat is a sign of stress. The MEA/EQUIMEA can efficiently detect the all of the heartrates, and separate them out. The allows the medical team monitoring the birth the ability to determine if one or several of the babies is under stress, and gives them in essentially real time an update of that information, which in turn gives them the ability to make informed decisions.

This analysis carries over to any biological process that monitors bio-rhythms.

Business Applications

Point processes and reliability control. The algorithms can be used to analyze the occurrence times of breakdowns or failures in a given system, a common topic in reliability analysis. By isolating the periodicities of these breakdowns in the systems, the proportion of failures that lead to overhauls (usually the most significant failures) can be controlled in the process of design. Many of these are discussed in J. H. Cha and M. Finkelstein's recent book Point Processes for Reliability Analysis: Shocks and Repairable Systems Springer Series in Reliability Engineering [50]. W. A. Thomas' Point Process Models with Applications to Safety and Reliability [55] discusses an example from the atomic energy industry. The rate of reaction in an atomic power plant is controlled at a safe level by the insertion of control rods. The times at which control is needed (called transients) are assumed to occur in operating time according to a Poisson process. A fundamental question is the underlying period. A. Karr's book “Point Processes and Their Statistical Inference (Second Edition)” [54] discusses reliability analysis of complex repairable systems by means of marked point processes. Again, the extraction of generating period(s) is key to the analysis of this data. These sentiments are echoed in Joseph Glaz and N. Balakrishnan's book “Scan statistics and applications, Statistics for Industry and Technology, Springer Science and Business Media” [53], which cites numerous applications. These examples are just the “tip of the iceberg.”

Risk analysis and point processes. V. Chavez-Demoulin, P Embrechts, and J. Neslehova's paper “Quantitative models for operational risk: Extremes, dependence and aggregation” in the Journal of Banking and Finance [51] discusses advanced peaks over threshold modelling, the construction of dependent loss processes and the establishment of bounds for risk measures under partial information. P. Glasserman and S. G. Kou's paper The term structure of simple forward rates with jump risk [52] in looks to analyze very general types of jump processes, modeled through marked point processes, allowing randomness in jump sizes and dependence between jump sizes, jump times, and interest rates. S. Yamanaka, M. Sugihara, and H. Nakagawa's Modeling of contagious credit events and risk analysis of credit portfolios in Asia-Pacific Financial Markets [56] discusses the role of point processes in this analysis, and introduces a method called “random thinning” to decompose a portfolio loss point process into the sum of its constituent loss point processes. The EQUIMEA algorithm would be useful in this analysis.

### Systems

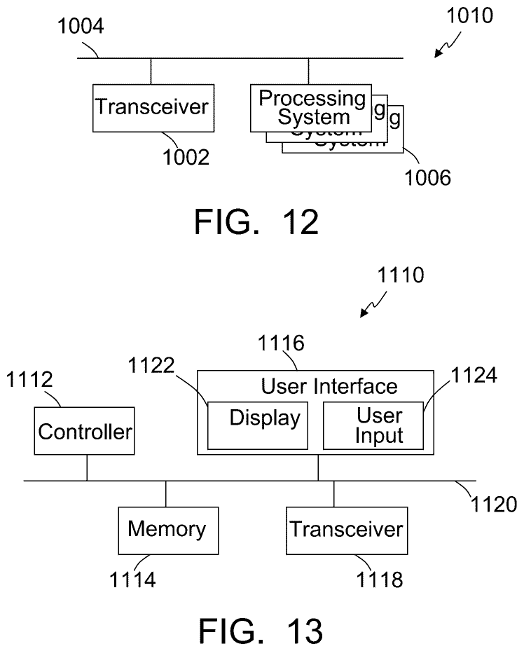

In FIG. 12, there is illustrated a system 1000 that may be used in processing data in accordance with at least some embodiments. The system 1000 can include a received and/or transceiver 1002, one or more communication links, paths, buses or the like 1004, and one or more processing systems, chips or units 1006. The transceiver 1002 can be configured to receive the signal to be processed. The processing systems 1006 can be substantially any circuitry, circuits, chips, ASICs and/or combinations thereof that can implement the processing, which can include but is not limited to one or more of perform the segmentin, the transform series expansion, the calculations, summations, sampling, transmitting, storing, analyzing, reconstructing, synthesizing, transmitting and the like. Similarly, the processing system 1006 may include one or more processors, microprocessors, central processing units, logic, local digital storage, firmware and/or other control hardware and/or software. As described above, in some instances, multiple phase cycling (e.g., three phase cycling, five phase cycling, etc.) may be implemented. As such, the system may include multiple processing systems 1006 to implement the multiple cycles.

The methods, techniques, systems, devices, services, and the like described herein may be utilized, implemented and/or run on many different types of devices and/or systems. Referring to FIG. 13, there is illustrated a system 1100 that may be used for any such implementations, in accordance with some embodiments. One or more components of the system 1100 may be used for implementing any system, apparatus, module, unit or device mentioned above or below, or parts of such systems, apparatuses, modules, unit or devices, such as for example any of the above or below mentioned circuitry, chips, ASICs, systems, processing systems 1006, processors, and the like. However, the use of the system 1100 or any portion thereof is certainly not required.

By way of example, the system 1100 may comprise a controller or processor module 1112, memory 1114, one or more communication links, paths, buses or the like 1120, and in some instances a user interface 1116. A power source or supply (not shown) is included or coupled with the system 1100. The controller 1112 can be implemented through one or more processors, microprocessors, central processing unit, logic, local digital storage, firmware and/or other control hardware and/or software, and may be used to execute or assist in executing the steps of the methods and techniques described herein, and control various transforms, analysis, transmissions, storage, reconstruction, synthesis, windowing, measuring, communications, programs, interfaces, etc. The user interface 1116, when present, can allow a user to interact with the system 1100 and receive information through the system. In some instances, the user interface 1116 may includes a display 1122, LEDs, audio output, and/or one or more user inputs 1124, such as keyboard, mouse, track ball, touch pad, touch screen, buttons, track ball, etc., which can be part of or wired or wirelessly coupled with the system 1100.

Typically, the system 1100 further includes one or more communication interfaces, ports, transceivers 1118 and the like allowing the system 1100 to at least receive signals, which can be communicated wired or wirelessly over substantially any communication medium (e.g., over a distributed network, a local network, the Internet, communication link 1120, other networks or communication channels with other devices and/or other such communications). Further the transceiver 1118 can be configured for wired, wireless, optical, fiber optical cable or other such communication configurations or combinations of such communications.

The system 1100 comprises an example of a control and/or processor-based system with the controller 1112. Again, the controller 1112 can be implemented through one or more processors, controllers, central processing units, logic, software and the like. Further, in some implementations the controller 1112 may provide multiprocessor functionality.

The memory 1114, which can be accessed by the controller 1112, typically includes one or more processor readable and/or computer readable media accessed by at least the controller 1112, and can include volatile and/or nonvolatile media, such as RAM, ROM, EEPROM, flash memory and/or other memory technology. Further, the memory 1114 is shown as internal to the system 1110; however, the memory 1114 can be internal, external or a combination of internal and external memory. The external memory can be substantially any relevant memory such as, but not limited to, one or more of flash memory secure digital (SD) card, universal serial bus (USB) stick or drive, other memory cards, hard drive and other such memory or combinations of such memory. The memory 1114 can store code, software, executables, scripts, data, signals, samples, coefficients, programming, programs, media stream, media files, identifiers, log or history data, user information and the like.

One or more of the embodiments, methods, processes, approaches, and/or techniques described above or below may be implemented in one or more processor and/or computer programs executable by a processor-based system. By way of example, such a processor based system may comprise the processor based system 1100, a computer, an encoder, an analog-to-digital converter, a player device, etc. Such a computer program may be used for executing various steps and/or features of the above or below described methods, processes and/or techniques. That is, the computer program may be adapted to cause or configure a processor-based system to execute and achieve the functions described above or below. For example, such computer programs may be used for implementing any embodiment of the above or below described steps, processes or techniques. As another example, such computer programs may be used for implementing any type of tool or similar utility that uses any one or more of the above or below described embodiments, methods, processes, approaches, and/or techniques. In some embodiments, program code modules, loops, subroutines, etc., within the computer program may be used for executing various steps and/or features of the above or below described methods, processes and/or techniques. In some embodiments, the computer program may be stored or embodied on a computer readable storage or recording medium or media, such as any of the computer readable storage or recording medium or media described herein.

Accordingly, some embodiments provide a processor or computer program product comprising a medium configured to embody a computer program for input to a processor or computer and a computer program embodied in the medium configured to cause the processor or computer to perform or execute steps comprising any one or more of the steps involved in any one or more of the embodiments, methods, processes, approaches, and/or techniques described herein. For example, some embodiments provide one or more computer-readable storage mediums storing one or more computer programs for use with a computer simulation, the one or more computer programs configured to cause a computer and/or processor based system to execute steps comprising: receiving a communication signal; adaptively partitioning the signal in a time domain into a plurality of segment of the signal; transforming each of the segments of the signal producing respective expansions in a frequency domain and obtaining respective samples of the windows of signal in the frequency domain; and mapping the samples in the frequency domain back into the time domain.

The present embodiments provide methods and systems configured to provide time-frequency analysis, including basis windowing systems providing signal time-frequency analysis. For example, some embodiments provide methods of processing signals. These methods can comprise: receiving a signal; adaptively partitioning the signal in a time domain into a plurality of segments of the signal; and transforming each portion of the signal of each segments producing respective expansions in a frequency domain and analyzing and/or obtaining respective samples of the respective expansions in the frequency domain. Some embodiments further map the samples in the frequency domain back into the time domain.

Many of the functional units described in this specification have been labeled as systems, modules, units, etc., in order to more particularly emphasize their implementation independence. For example, a system or module may be implemented as a hardware circuit comprising custom VLSI circuits or gate arrays, off-the-shelf semiconductors such as logic chips, transistors, or other discrete components. A system and/or module may also be implemented in programmable hardware devices such as field programmable gate arrays, programmable array logic, programmable logic devices or the like.

Some or all of the systems and/or modules may also be implemented in software for execution by various types of processors. An identified system and/or module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a system or module of executable code could be a single instruction, or many instructions, and may even be distributed over several different code segments, among different programs, and across several memory devices. Similarly, operational data may be identified and illustrated herein within systems or modules, and may be embodied in any suitable form and organized within any) suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

### REFERENCES

[1] Ayoub, R., Euler and the zeta function, Amer. Math. Monthly 81, 1067-1086 (1974).
[2] Beukers, F., Calabi, E., and Kolk, J. A. C., Sums of generalized harmonic series and volumes, Nieuw Arch. Wisk. 11 (4), 217-224 (1993).
[3] Blum, J. R., and Mizel, V. J., A generalized Weyl equidistribution theorem for operators, with applications Trans. AMS 165, 291-307 (1972).
[4] Borwein, J. M., Bradley, D. M., and Crandall, R. E., Computational strategies for the Riemann zeta function, J. Comp. App. Math. 121, 1-68 (2000).
[5] Breiman, L., Probability, Addison-Wesley, Reading, Massachusetts (1968).
[6] Casey, S. D., and Sadler, B. M., Pi, the primes, periodicities and probability, The American Mathematical Monthly, 120 (7), 594-608 (2013).
[7] Casey, S. D., and Sadler, B. M., Modifications of the Euclidean algorithm for isolating periodicities from a sparse set of noisy measurements, IEEE Trans. SP, 44 (9), 2260-2272 (1996).
[8] Casey, S. D., and Sadler, B. M., A modified Euclidean algorithm for isolating periodicities from a sparse set of noisy measurements, IEEE International Conference on Acoustics, Speech and Signal Processing (ICASSP '95) 3, 1764-1767 (1995).
[9] Casey, S. D., Number theoretic methods in parameter estimation, Proceedings of IEEE Workshop on Statistical Signal and Array Processing, 406-409 (1996).
[10] Casey, S. D., Sampling issues in least squares, Fourier analytic and number theoretic methods in parameter estimation, Proc. 31st Asilomar Conf. on Sig. Syst. and Comp., 453-457 (1997).
[11] Cohen, G. L., On relatively prime numbers and oil drops, Int. J. Math. Educ. Sci. Technol. 24 (3), 417-422 (1972).
[12] Conway, J. B., Functions of One Complex Variable (Second Edition), Graduate Texts in Mathematics, Vol. 11, Springer-Verlag, New York (1978).
[13] Dunham, W., Euler: The Master of Us All, Dolciani Mathematical Expositions, Number 22, Mathematical Association of American, Washington, DC (1999).
[14] Dym, H., and McKean, H. P., Fourier Series and Integrals, Academic Press, Orlando, Florida (1972).
[15] Edwards, H. M., Riemann's Zeta Function, Academic Press, New York, New York (1974).
[16] Elkies, N. D., On the sums Σ_{k=-∞}^{∞}(4k+1)⁻ⁿ, Amer. Math. Monthly 110, 561-573 (2003).
[17] Euler, L., De Summis Serierum Reciprocarun, Commentarii Academiae Scientiarum Petropolitanae 7, 123-134 (1740).
[18] Ferguson, H. R. P., and Forcade, R. W., Generalization of the Euclidean algorithm for real numbers to all dimensions higher than two, Bull. (New Series) AMS 1 (6), 912-914 (1979).
[19] Ferguson, H. R. P., Bailey, D. H., and Arno, S., Analysis of PSLQ, an integer relation finding algorithm, Mathematics of Computation 68 (25), 351-369 (1999).
[20] Fogel, E., and Gavish, M., Performance evaluation of zero-crossing-based bit synchronizers, IEEE Transactions on Communications, 37 (6), 663-665 (1989).
[21] Hardy, G. H., A Mathematician's Apology (First Canto Edition), Cambridge University Press, Cambridge (1992).
[22] Hardy, G. H., and Wright, E. M., An Introduction to the Theory of Numbers (Fifth Edition), The Clarendon Press, Oxford University Press, Cambridge (1979).
[23] Huillet, T., and Raynaud, H.-F., Modelling extremal events using Gnedenko distributions, J. Phys. A: Math. Gen., 32, 1099-1113 (1999).
[24] Ireland, K., and Rosen, M., A Classical Introduction to Modern Number Theory, Graduate Texts in Mathematics, Vol. 84, Springer-Verlag, New York (1982).
[25] Kalman, D., Six ways to sum a series, The College Mathematics Journal, 24 (5), 402-421 (1993).
[26] Katok, A. B, and Stepin, A. M., Approximations in ergodic theory, Uspehi Mat. Nauk, 77-102 (1967).
[27] Knuth, D. E., and Buckholtz, T. J., Computation of tangent, Euler and Bernoulli numbers, Math. Comp. 21, 663-688 (1967).
[28] Knuth, D. E., The Art of Computer Programming, Vol. II: Seminumerical Algorithms, second edition. Addison-Wesley, Reading, Massachusetts (1981).
[29] Knuth, D. E., The Art of Computer Programming, Vol. III: Sorting and Searching. Addison-Wesley, Reading, Massachusetts (1973).
[30] Körner, T. W., Fourier Analysis, Cambridge University Press, New York (1988).
[31] Lake, D., Sadler, B. M., and Casey, S. D., Detecting regularity in minefields using collinearity and a modified Euclidean algorithm, Proc. SPIE, 3079, 234-241 (1997).
[32] Lal. M., and Gillard, P., Table of Euler's phi function, n<10⁵, Math. Comp. 23, 682-683 (1969).
[33] Lal. M., and Gillard, P., Table of Euler's phi function, n<10⁵, Memorial University of Newfoundland, St. John's, Newfoundland, 200 pp. (1968).
[34] Leveque, W. J., Topics in Number Theory, Volumes 1 and 2, Addison-Wesley, Reading, Massachusetts (1956).
[35] Kleinbock, D. Y., and Margulis, G. A., “Flows on homogeneous spaces and Diophantine approximation on manifolds,” Annals of Mathematics (Second Series), 148 (1), 339-360 (1998).
[36] Mertens, F., Ueber einige asymptotische Gesetze der Zahlentheorie, Journal fur die reine and angewandte Mathematik (Crelle's Journal), 77, 289-338 (1874).
[37] Nishiguchi, K., and Kobayashi, M., Improved algorithm for estimating pulse repetition intervals, IEEE Transactions on Aerospace and Electronic Systems, 36 (2), 408-421 (2000).
[38] Nymann, J. E., On the probability that k positive integers are relatively prime, Journal of Number Theory, 4, 469-473 (1972).
[39] Reiss, R.-D., Approximate Distributions of Order Statistics. Springer-Verlag, New York (1989).
[40] Riemann, B., Ueber die Anzahl der Primzahlen unter einer gegenbenen Grösse, Preuss. Akad. der Wissen. zu Berlin (1859).
[41] Rosen, K. H., Elementary Number Theory and Its Applications (Fourth Edition), Addison-Wesley, Reading, Massachusetts (2000).
[42] Sadler, B. M. and Casey, S. D., Sinusoidal frequency estimation via sparse zero crossings, Jour. Franklin Inst. 337, 131-145 (2000).
[43] Sadler, B. M. and Casey, S. D., On pulse interval analysis with outliers and missing observations, IEEE Trans. SP, 46 (11), 2990-3003 (1998).
[44] Sadler, B. M. and Casey, S. D., Frequency estimation via sparse zero-crossing, Proc. Intl. Conf. on Acoustics, Speech and Sig. Proc. (ICASSP-96) 5, 2990-2993 (1996).
[45] Contributions to Order Statistics. Edited by Sarhan, A. E., and Greenberg, B. G., John Wiley, New York (1962).
[46] Schroeder, M. R., Number Theory in Science and Communication (Second Edition), Springer-Verlag, Berlin (1986).
[47] Sidiropoulos, N. D., Swami, A., and Sadler, B. M., Quasi-ML period estimation from incomplete timing data, IEEE Transactions on Signal Processing 53 (2), pp. 733-739 (2005).
[48] Walters, P., An Introduction to Ergodic Theory, Springer-Verlag, New York (1982).
[49] Zagier, D. B., Zeta Functions in Number Theory, Annual meeting of the American Mathematical Society, Phoenix, Arizona, January 1989.
[50] J. H. Cha and M. Finkelstein, Point Processes for Reliability Analysis: Shocks and Repairable Systems Springer Series in Reliability Engineering, New York (2018).
[51] V. Chavez-Demoulin, P Embrechts, and J. Neslehova, “Quantitative models for operational risk: Extremes, dependence and aggregation,” Journal of Banking and Finance 30 (10), pp. 2635-2658 (2006).
[52] P. Glasserman and S. G. Kou, “The term structure of simple forward rates with jump risk,” Mathematical Finance, 13 (3) pp. 383-410 (2003).
[53] J. Glaz and N. Balakrishnan Scan statistics and applications, Statistics for Industry and Technology, Springer Science and Business Media, New York (1999).
[54] A. Karr, Point Processes and Their Statistical Inference (Second Edition), Marcel Dekker, Inc., New York (1991).
[55] W. A. Thomas, Point Process Models with Applications to Safety and Reliability, Chapman and Hall, London (1988).
[56] S. Yamanaka, M. Sugihara, and H. Nakagawa, “Modeling of contagious credit events and risk analysis of credit portfolios,” Asia-Pacific Financial Markets, 19 (1), pp. 43-62 (2012).

I claim:

1. A method to analyze data from multiple periodic processes and deinterleave those periods; the method comprising the steps of:
providing process data for analysis from at least one periodic generator;
identify underlying different periodic processes;
providing a Modified Euclidean Algorithm (MEA) to extract a fundamental period from a set of sparse and noisy observations of a periodic process;
relying on the probabilistic interpretation of an equidistributed MEA (EQUIMEA) to deinterleave processes with multiple periods; and
outputting the deinterleaved data to be applied to desired applications and analyses.

2. The method of claim 1, wherein the method converges to the exact value of the period with as few as ten data samples.

3. The method of claim 1, wherein the desired applications and analyses are selected from the group consisting of communication and signal processing in the fields of traditional radio transceivers using frequency-division multiplexing, bio-rhythms, aggregate business data, astronomy, biomedical, physical systems, reliability and quality control systems, signal analysis of radar and sonar systems, queuing in business applications, analysis of neuron firing rates in computational neuroscience, bit synchronization in communications, fading communication channels, hop times of frequency-hopping radios, and detecting patterns in spatial point processes.

4. The method of claim 1, wherein the MEA processes provide that for a set of randomly chosen positive integers, the probability they do not all share a common prime factor approaches one quickly as the cardinality of the set increases.

5. The method of claim 1, wherein the EQUIMEA processes include an extraction of a set of fundamental periods by using Weyl's Equidistribution Theorem to help separate sources.

6. The method of claim 1, wherein the deinterleaving processes use convolution with appropriate pulse trains.

7. The method of claim 3, wherein signal processing of hop times uses standard signal processing tools of discrete Fourier transforms and convolution operators; and non-standard tools of abstract algebra and number theory.

8. The method of claim 3, wherein the detecting patterns in spatial point processes are used to determine co-linearity in minefields.

9. The method of claim 1, wherein the providing a first procedure to extract a fundamental period first assumes that S is noise free, then adjusting for noise.

10. A method to analyze data from multiple periodic processes and deinterleave those periods; the method comprising the steps of:
1.) [Adjoing 0.] Sᵢₜₑᵣ←S∪{0};
2.) [Sorting.] Sort the elements of Sᵢₜₑᵣ in descending order;
3. [Computing all differences.] Set Sᵢₜₑᵣ=∪(sⱼ−sₖ) with sⱼ>sₖ;
4.) [Eliminating noise.] If 0≤sⱼ≤η₀, then S←S\{sⱼ};
5.) [Adjoining previous iteration.] Form Sit Sᵢₜₑᵣ←Sᵢₜₑᵣ∪Sᵢₜₑᵣ₋₁; sort and reindex;
6.) [Computing spectrum.] Compute
$$\vert {Spec}_{iter} ( τ ) \vert = \vert {\sum }_{l = 1}^{N} {e}^{( \frac{2 {πis}_{l}}{τ} )} \vert ;$$
7.) [Thresholding.] Choosing the rightmost peak. Label it as τᵢₜₑᵣ;
8.) If |Specᵢₜₑᵣ(τᵢₜₑᵣ)|>ε_{β} or |τᵢₜₑᵣ−τᵢₜₑᵣ₋₁|<ε_{η}, declaring [symbol] =τᵢₜₑᵣ;
If not, iter←(iter+1). Go to 1.);
9.) Given τᵢ, removing it and its harmonics |Specᵢₜₑᵣ(τ)| for [symbol] /m, m∈ [symbol] . Labeling as Notchᵢₜₑᵣ(τ);
10.) [Recomputing frequency notched spectrum.] Compute |Specᵢₜₑᵣ(τ)−Notchᵢₜₑᵣ(τ)|;
11.) [Thresholding.] If |Specᵢₜₑᵣ(τ)−Notchᵢₜₑᵣ(τ)|≤ε_{β} algorithm terminates.
Else, let i←i+1; and
12.) [Deinterleaving the data].

11. The method of claim 10, wherein the step of detinerleaving the data comprises:
correlating a known delayed signal with an unknown signal to detect the presence of the template in the unknown signal using discrete matched filtering; and
convolving the data given the original data and the set of generating periods to identify the elements in the original data.
